(19) United States
(12) Patent Application Publication
(10) Pub. No.: US 2014/0238939 A1
(43) Pub. Date: Aug. 28, 2014

(54) IMMOBILIZATION OF ANTIMICROBIAL POLYMERS ON RO MEMBRANE TO REDUCE BIOFILM GROWTH AND BIOFOULING

(71) Applicants: Ron Kasher, Ben-Gurion (IL); Shani Avneri, Zichron Yaakov (IL); Marina Yamit Lutsky, Beer-Sheva (IL); Jihua Zhang, St. Paul, MN (US); Samuel Helmer Gellman, Madison, WI (US); Shannon Stahl, Madison, WI (US)

(72) Inventors: Ron Kasher, Ben-Gurion (IL); Shani Avneri, Zichron Yaakov (IL); Marina Yamit Lutsky, Beer-Sheva (IL); Jihua Zhang, St. Paul, MN (US); Samuel Helmer Gellman, Madison, WI (US); Shannon Stahl, Madison, WI (US)

(73) Assignees: WISCONSIN ALUMNI RESEARCH FOUNDATION, Madison, WI (US); BENIGURION UNIVERSITY OF THE NEGEV RESEARCH AND DEVELOPMENT AUTHORITY, Beer-Sheva (IL)

(21) Appl. No.: 14/126,759

(22) PCT Filed: Jun. 14, 2012
(86) PCT No.: PCT/IL2012/000237

§ 371 Date: Apr. 7, 2014

Related U.S. Application Data
(60) Provisional application No. 61/497,066, filed on Jun. 15, 2011.

(51) Int. Cl. B01D 65/08; C02F 1/44; B01D 71/62; B01D 71/38; B01D 71/56

(52) U.S. Cl. CPC B01D 65/08; B01D 71/38; B01D 71/56; B01D 71/62; C02F 1/44
USPC 210/650; 210/500.21; 210/500.36; 210/500.35; 210/500.28; 210/500.37; 525/426; 525/66

(57) ABSTRACT

The present invention discloses antimicrobial water treatment membranes, comprising a water treatment membrane, covalently attached to one or more antimicrobial polymers or derivatives thereof, either directly or via one or more tether molecules. There are also provided a process for preparing these antimicrobial membranes, and uses thereof in water treatment applications.

Thin-film composite (TFC) membranes for reverse osmosis (RO) and nanofiltration (NF) technologies are widely used in water desalination, ultra-pure water production and waste water treatment, and are presently the most common membranes used in technologies for drinking water production. Biofilm formation due to the accumulation and adhesion of microorganisms, which results in biofouling of membranes, is considered among the most difficult problems in membrane-based water technologies.

One current method for prevention and treatment of biofilm is pretreatment of the feed in RO applications to limit biofouling. This is a costly method which requires additional equipment, and is not very efficient due to the continuous supply of nutrients in the feed which promotes and accelerates biofilm formation on the membrane surface. A second method is periodical cleaning of the RO membrane module, for example by using detergents and alterations of acidic (usually citric acid) and basic solutions. However, this practice requires suspending of desalination process, which reduces its capacity. Furthermore, biofilm removal by cleaning is not effective enough, and there is no backwash in RO, and hence biofilm gradually accumulates.

Another strategy involves modification of the membrane surface to render it less susceptible to biofouling. For example, the hydrophilic character of the membrane surface can be increased by graft polymerization using hydrophilic monomers onto RO and NF membranes (e.g., Belfer et al. Journal of Membrane Science 55-64, 239, 2004). These methods, while improving membrane resistance to organic fouling, have not been successful in preventing biofouling.

Effective prevention of microbial growth on membranes has until recently been achieved only when a continuous, high chlorine concentration is maintained. However, chlorine generates harmful by-products upon reaction with organic matter, making this method unsuitable for most water treatment applications. Additionally, the most commonly used water treatment membranes are sensitive to oxidizing agents such as chlorine and ozone.

Some of the present inventors have recently successfully developed (WO 2011/070573) treatment membranes, which comprise conventional water treatment membranes linked to suitable antimicrobial polymers or their suitable derivatives, optionally and preferably via pre-defined spacers (tethers) and linkers. The obtained membranes have been shown to have proven antibacterial activity as well as stability, and can be used in both saline and non-saline environments, thus rendering them suitable for a wide variety of water purification applications which are susceptible to biofouling and biofilm formation.

Antimicrobial polymers have been described in recent years as an alternative antimicrobial family of synthetic compounds (see for example a review by Siedenbiedel, F. and Tiller, J. C., Polymers 2012, 4, 46-71).

Recently, nylon-3 copolymers have been prepared via ring-opening polymerization of beta-lactams, and have been found to display antimicrobial activity similar to that of natural antibiotic peptides (Mowery B P et al., JACS 2009; 131(28):9735-9745). Many of host-defense peptides are believed to adopt a specific conformation in the biologically active form, which leads to spatial segregation of lipophilic and cationic side chains. This conformation is induced at the target bacteria membrane surface. Nylon-3 copolymers which contain a random sequence of cationic and lipophilic β-amino acid subunits were hypothesized to adopt irregular conformation that results in global amphiphilicity in solution which provides them their antimicrobial character, as in the case of antimicrobial peptides.

The most active polymers prepared to date were generated from two types of beta-lactams, one that bears a hydrophobic appendage and another that bears a protected amino group as an appendage.

These polymers are advantageous over antimicrobial peptides in that they have:
an activity against a range of bacteria, including both Gram positive and Gram negative species;
a selectivity for prokaryotic cells relative to eukaryotic cells; and
a simpler synthesis with less expensive starting materials as compared to the labor-intensive and expensive production of peptides, thereby facilitating their preparation on a large scale;
an inherent stability to enzymes due to the synthetic character thereof.

So far, methods for attaching antimicrobial polymers to RO membrane surfaces with the aim of bestowing these surfaces with anti microbial properties, have not been described. For example, there is some evidence that antibacterial polymers, may be unsuitable for immobilization on surfaces. Therefore even a person skilled in the art cannot anticipate which, if any, antimicrobial polymers may be suitable to be immobilized on a surface (such as a membrane) or what the antifouling properties of such a membrane would be.

In addition—since it is clear that synthetic polymers are completely different in their properties from natural (antimicrobial) peptides, it becomes impossible to deduct the properties of membranes comprising synthetic polymers, from those of membranes containing natural peptides.

Thus, to date, there has been no report on the use of surface-attached antimicrobial polymers as antibacterial agents for the prevention of biofilm growth and biofouling of Water treatment membranes in processes of water treatment.

As explained hereinabove, presently, the prevention and treatment of biofilm formation on water treatment membranes is a major obstacle in water treatment processes, acting as a barrier to large scale utilization of these membranes. A safe and efficient solution for the problem of biofouling of water treatment membranes is greatly needed.

The present inventors have now developed novel antibacterial water treatment membranes, which comprise conventional water treatment membranes, linked to suitable antimicrobial polymers or their suitable derivatives, optionally and preferably via pre-defined spacers (tethers) and linkers.

As shown in the experimental section which follows, these modified membranes have proven antibacterial activity as well as stability, and can be used in both saline and non-saline environments, thus rendering them most suitable for a wide variety of water purification applications which are susceptible to biofouling and biofilm formation.

Thus, according to one aspect of the invention, there is provided an antimicrobial water treatment membrane comprising a water treatment membrane, covalently attached to one or more antimicrobial polymers or derivatives thereof, either directly or via tethers (spacers) and/or linkers.

Water treatment membranes are classified according to their permeability and uses, as detailed above. The present invention is suitable for Reverse Osmosis (RO) membranes, Nano Filtration (NF) membranes, and also for Ultra Filtration (UF) and Micro Filtration (MF) membranes, as long as these membranes can covalently link, or can be modified to link, to an antimicrobial polymer either directly or via a tether molecule.

Preferably, the water treatment membrane of the present invention is an RO or NF membrane.

According to preferred embodiments of the invention, the membrane is selected from thin film composite (TFC) membranes, cellulose acetate membranes, other esters of cellulose, ultrafiltration membranes such as polyethersulfone (PES), polysulfones, chlorinated polyvinyl chloride (PVC) or polyvinylidene fluoride (PVDF).

The term “thin film composite (TFC) membrane” defines a semi-permeable membrane composed of a polymer constructed in the form of a film from two or more layered materials. TFC membranes, sometimes termed TFM, are mainly used in water purification or water desalination systems (in reverse osmosis (RO), nanofiltration (NF) and ultrafiltration (UF) applications) but are also used in chemical applications such as batteries and fuel cells.

TFC membranes for RO and NF applications may be prepared from polyethyleneimine/toluene-diisocyanate, polyepiamine, polypiperazine-amide, polypiperazine-trimesamide and many others [see a review: Petersen, R. J. Journal of Membrane Science 83, 81-150 (1993)]. The most common TFC membrane for RO and NF membranes is an aromatic polyamide membrane, namely that the outer film is made of an aromatic polyamide and therefore has free carboxylic groups attached to it. These carboxylic groups can then link directly to a polymer via its amine side to form amide bonds, or it can be used to attach other chemical groups to it, so as to enable covalently attaching a polymer or a tether linked to a polymer, thereto.

The most common TFC membrane for Ultrafiltration (UF) membranes is a polysulfone or polyethersulfone membrane, namely that the outer film is made of a polysulfone.

The term “antimicrobial polymer” as used herein includes synthetic polymers, having an antimicrobial activity, which is the ability to prevent, inhibit, reduce or destroy one or more microorganism.

In particular, the present invention includes polymers having an antimicrobial activity against microorganisms causing the formation of biofouling or biofilm formation.

Therefore, antimicrobial polymers suitable for the present invention are preferably those that have the ability to prevent, inhibit, reduce or destroy biofilm-forming microorganisms.

The term “microorganism” as used herein refers to bacteria (Gram-positive or Gram-negative), fungi, alga or protozoa. Therefore, biofilm-forming microorganism include bacteria, yeast, fungi and alga and protozoa that are capable of forming biofilm or of causing biofouling.

The term “biofilm” refers to biological films that develop and persist at interfaces in aqueous environments. Biofilm forms when bacteria adhere to surfaces in moist environments by excreting a slimy, glue-like substance made of sugary molecular strands, collectively termed “extracellular polymeric substances” or “EPS.”

Biofilm-forming bacteria include, but are not limited to, Listeria, Salmonella, Campylobacter, Escherichia coli, Pseudomonas, lactic acid-producing bacteria, Enterobacteria, Klebsiella species, Citrobacteria, Streptococcus, Rodococcus, Bacilus etc.

The antimicrobial activity of a polymer against a biofilm-forming microorganism can be determined by a method depending on the specific film-forming microorganism in question, and is typically provided as an IC₅₀ value.

The term “IC₅₀” refers to the concentration of compound (in this case the antimicrobial polymer) needed to reduce biofilm growth or accumulation of certain microorganism by 50% in vitro or in situ.

The IC₅₀ is determined by an essay, suitable for the specific film-forming microorganism in question. For example, in the present invention, the Enterobacter assay, which is described in detail in the methods section below, was used to determine the antimicrobial activities of the tested polymers.

The antimicrobial polymers suitable for the present invention are characterized by an IC₅₀ against at least one species of biofilm-forming microorganism, of up to 200 μg/ml, preferably of up to 150 μg/ml, more preferably of up to 100 μg/ml and most preferably of up to 50 μg/ml.

As can be seen in Table 4, the antimicrobial polymers of the present invention had IC₅₀ values as low as 0.5 μg/ml, and generally in the range of 0.5-2.4 μg/ml to the film-forming Enterobacter, under the assay described in 96-microtitter plates (see Experimental section hereinbelow).

Since synthetic polymers, such as those used for the present invention, are inherently stable against proteolysis, they are advantageous for use in the present invention. This is especially important as during biofilm formation, bacteria excrete proteases which may degrade natural compounds, such as peptides, and therefore it is advantageous that the antimicrobial polymers are resistant to proteolysis.

Resistance to proteolysis can be determined according to trypsin, chymotrypsin or pronase E assay, for example by adding to each 90 μl of polymer solution, 10 μl of enzyme solution, containing either a mixture of 0.5 μg trypsin (0.05 mg/ml) and 0.5 μg chymotrypsin (0.05 mg/ml) or 4 μg pronase E (0.4 mg/ml) in 0.001M HCl and monitoring any enzymatic degradation at controlled temperature of 25° C. A compound can be considered to be resistant to proteolysis if it withstands this assay for at least 1 week, maintaining at least 90% of its initial concentration after this period.

It should be noted that in addition to the requirement of antimicrobial activity of the polymers, it is also necessary that the polymers can be covalently attached to the membrane and/or to the tether and/or linker, as described hereinabove.

Since some water purification applications involve saline environments, for example in desalination applications, it is necessary that the antimicrobial polymers shall retain their activity under such conditions. Therefore, according to additional embodiments of the invention, polymers that are microbicidally active in high concentrations of salt are used.

The term “microbicidally active” as used herein, refers to a polymer having an IC₅₀ of up to 200 μg/ml, preferably up to 150 μg/ml, more preferably of up to 100 μg/ml and most preferably of up to 50 μg/ml against at least one species of biofilm-forming microorganisms.

The term “high concentrations of salt” as used herein refers to a concentration of 3% NaCl.

It has been found by the inventors that although the polymers can be attached directly to the water treatment membranes, they are preferably attached to it via a tether molecule. Without being bound to a specific theory, it is thought that the tether allows a degree of freedom and movement to the polymers, such that contact with the microorganism (for example, the bacteria) is enabled and creates a “brush” effect that increases its efficiency against biofilm forming microorganisms. For this reason the tether should also help position the polymer relative to the membrane, mainly to maintain a distance between the polymer and membrane surface.

Thus, according to a preferred embodiment there is provided an antimicrobial water treatment membrane comprising a water treatment membrane, covalently attached to one or more antimicrobial polymers or derivatives thereof via one or more tether molecules.

According to a preferred embodiment of the present invention, there is provided an antimicrobial water treatment membrane comprising a water treatment membrane, covalently attached to one or more antimicrobial polymers or derivatives thereof via one or more tether molecules, wherein the antimicrobial polymer has an IC₅₀ value of up to 200 μg/ml against at least one biofilm-forming microorganism. This membrane is inherently stable against proteolysis, for at least 1 week and longer.

The term “covalently attached” as used herein, generally refers to an attachment of one molecular moiety to another molecular moiety through covalent chemical bonds. This term does not exclude the existence of other levels of chemical and/or physical bonding, such as hydrophobic bonds, hydrogen-hydrogen bonds etc, in addition to the existence of covalent bonding. Furthermore, the term “covalently attached” may also include strong complex-ligand attachment, as long as it is stable in aqueous conditions such as Avidin/biotin complexation.

Examples of suitable covalent bonds that may form between the membrane and the polymer, or between the membrane and the tether, or between the tether and/or linker and the polymer include, but are not limited to:
an amide bond: R—CO—NH—R′;
a thioether bond: R—S—CH₂—R′;
a carbon-carbon covalent bond: C—C; and
a carbon-nitrogen bond: CR₂—NH—CR′₂—

Additional possible bonds include an azide-alkyne bond, a hydrazine-aldehyde bond, and an Avidin-biotin (host-guest) complexation.

For example if the membrane is a polyamide and has free carboxyl groups which attach directly with an amine side group on the polymer, the covalent bond between them would be an amide bond. A similar bond forms between a polyamide membrane and a tether having an amine terminal group.

If however, the membrane or tether linked to it, are attached to a maleimide (MI) molecule, which then attaches to a thiol group on the tether or on the polymer, a covalent thioether bond is formed.

Thus, according to additional embodiments of the invention, the polymer is intentionally modified to include a thiol group as a terminal group. Preferably, this is conducted during polymerization by adding a second stage reaction with a monomer that bears a protected thiol group. Additional modifications include adding a linking group, such as maleimine (MI) to the polymer. These and other modifications are included in the scope of the term “modified polymer”, as used herein and may be referred to as polymer derivatives.

Some examples of antimicrobial polymers, suitable for use in the present invention, include, but are not limited to, polylactams, poly-amino acids and polymers containing tertiary and/or quaternary ammonium groups ammonium groups. A combination of different polymers may also be used.

Additional groups of antimicrobial polymers are known to a person skilled in the art, and some of which are described in Siedenbiedel, F. and Tiller, J. C., Polymers 2012, 4, 46-71.

The term “poly-amino acids” as used herein includes hydrolyzed and non-hydrolyzed poly-amino acids. Hydrolyzed polyamino acids are anhydropolyamino acids which have been reacted or hydrolyzed with at least one common base or acid. The term “poly-amino acids” as herein defined is also meant to include homopolymers of amino acids and copolymers of amino acids. The term “homopolymers of amino acids” refers to poly-amino acids having only one type of repeating unit, where the repeating unit is derived from the reaction of at least one compound. For example, a homopolymer of aspartic acid, poly(aspartic acid), may be formed from the reaction of either aspartic acid, maleamic acid, ammonium salts of maleic acid, or ammonium salts of malic acid. Poly(aspartic acid), for example, may also be formed from the reaction of aspartic acid and maleamic acid, or aspartic acid and ammonium salts of maleic acid. The term “copolymers of amino acids” refers to poly-amino acids containing at least two different types of repeating units where the repeating units are derived from the reaction of at least two different compounds. This definition of copolymer includes copolymers of two amino acids, provided that the repeating units formed when the two amino acids are reacted are not the same. For example, a copolymer of aspartic acid and histidine may be formed from the reaction of aspartic acid and histidine. The poly-amino acids may also be random, sequential, or block polymers.

The poly-amino acids are synthesized by techniques well known to those skilled in the art. For example, they may be synthesized by naturally occurring biochemical processes or by synthetic chemical processes. Suitable processes, for example, are disclosed in “The Peptide Bond” in The Peptides: Analysis, Synthesis, Biology, edited by E. Gross and J. Meienhofer, published by Academic Press, NY, Vol 1, pages 1-64 (1979). A preferred method for synthesizing the poly-amino acids is disclosed in U.S. Pat. No. 5,318,145. U.S. Pat. No. 5,318,145 discloses a condensation reaction method for preparing poly-amino acids. The process utilizes heat and mild agitation to condense and polymerize the amino acids, auric acids, ammonium salts of monoethylenically unsaturated dicarboxylic acids, ammonium salts of hydroxypolycarboxylic acids, and optional additional monomers.

Polymers containing tertiary amine groups include, but are not limited to, poly(phenylene ethynylene)-based polymers, random copolymer class of dimethylaminomethyl styrene and octylstyrene (which is antimicrobially active upon protonation of the tertiary amino groups). Similar copolymers have been prepared by copolymerizing dimethylaminoethylacrylamide and aminoethylacrylamide, respectively, with n-butylacrylamide, and have been found to be antimicrobially active. Poly(diallylammonium salts that contain either secondary or tertiary amino groups also show excellent activity against S. aureus and Candida albicans. Besides linear polymers, dendritic and hyperbranched polymers have also been described to exhibit strong antimicrobial properties, e.g., quarternized, hyperbranched.

The term “polylactams”, used interchangeably with the term “polyamides” refers to polymers containing monomers of amides (also termed “lactams”) joined by peptide bonds. They can occur both naturally and artificially, examples being proteins, such as wool and silk, and can be made artificially through step-growth polymerization or solid-phase synthesis, examples being nylons, aramids, and sodium poly(aspartate).

Some examples of polylactams include, but are not limited to, polymers of 2-pyrrolidone, or caprolactam, etc.

The term “polylactams” also includes copolymers of different lactams, such as, for example, copolymers of caprolactam or 2-pyrrolidone with each other or other lactams.

Most polylactams are prepared by condensation poltmerization. However, in some cases, polylactams (for example nylon-6 or nylon-3) can be prepared by ring-opening polymerization of beta-lactams.

As noted hereinabove, antimicrobial polymers based on nylon-3 copolymers have recently been found to act as antimicrobial agents (Mowery B P et al., JAGS 2009; 131(28):9735-9745), and it was claimed that the mechanism of action resembles that of antimicrobial peptides. Nylon-3 copolymers were found to display promising biological characteristics, such as antibacterial activities, cell-adhesion properties, or lung-surfactant mimicry. They share benefits of antimicrobial peptides, which include: (1) activity against a range of bacteria, including both Gram positive and Gram negative species; (2) selectivity for prokaryotic cells relative to eukaryotic cells; and (3) low probability of bacteria to develop resistance because of the membrane-based mechanism of action.

Therefore, according to preferred embodiments of the invention, antibacterial polymers suitable for use in the present invention and having the groups described herein are polylactams, such as the selected Nylon-3 antibacterial random polylactam copolymers described hereinbelow.

Scheme 1 presents the preparation and structures of selected antibacterial 37:63 CH:MM nylon-3 random copolymers.

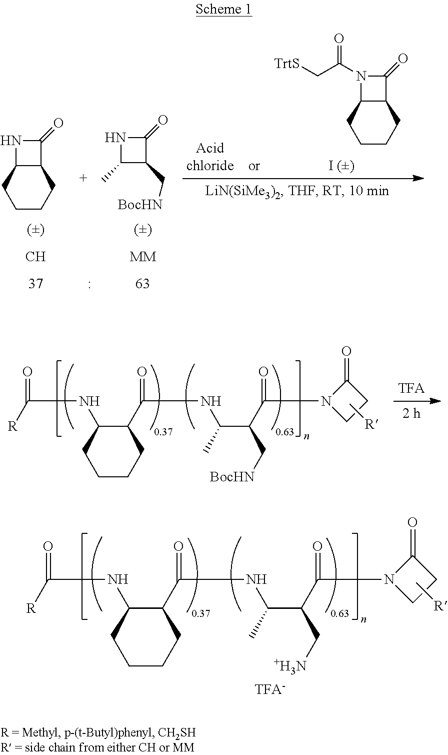

This process uses the monomers “CH” and “MM”, the structures of which are provided in Scheme 2 below (the abbreviations CH and MM are referred to throughout the specification):

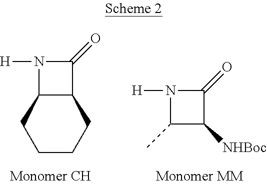

It has been found that random copolymers with the ratio of 40:60 are comparable in antibacterial activity to representative antimicrobial peptides, especially for Gram-positive species. Optimal behavior for the nylon-3 copolymer was achieved from a mixture of β-lactams which contains 63% of the hydrophilic monomer (“MM”).

In addition, β-lactams bearing desired functional groups (A and B), the structures of which are provided in Scheme 3 below, were used as the nucleophile in the functionalization of the C-terminus of the above random polylactam copolymers.

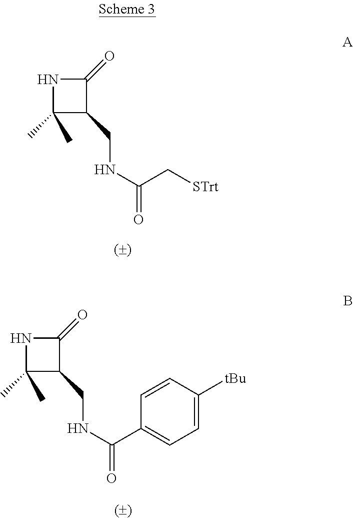

Scheme 4 presents the proposed procedure of C-terminal functionalization of 37:63 CH:MM nylon-3 random copolymers using β-lactam bearing a functionalized side chain as nucleophile.

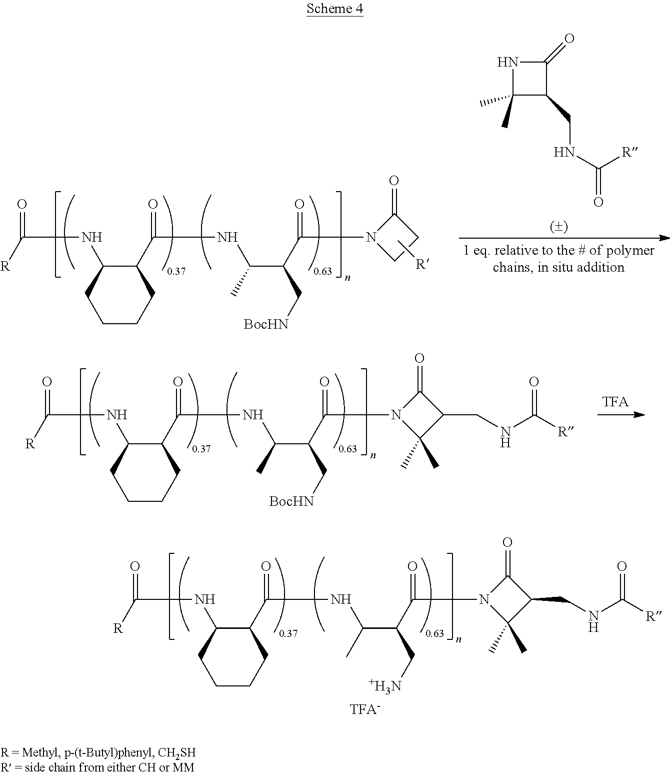

Less than stoichiometric (0.8-0.85 eq.) or stoichiometric β-lactam nucleophiles were added in-situ once the polymerization was completed (10 minutes). The degree of C-terminal functionalization was estimated by ¹H NMR or Ellman's test, and appears in Table 1 below.

TABLE 1
The degree of C-terminal functionalization of
polymers generated from selected 37:63 CH:MM nylon-3 random
copolymers using functionalized β-lactam as nucleophile.

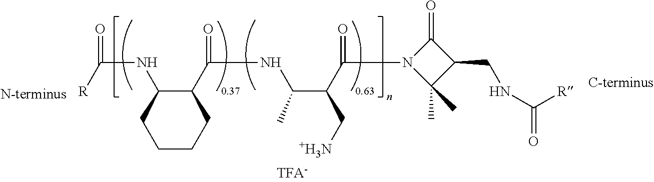

| Polymer | | | | | |
|---|---|---|---|---|---|
| Name | Batch | R | R″ | Eq^{a} | F^{b} |
| Z-1 | 87 17 | 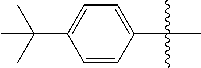 [SMILES: *c1ccc(C(C)(C)C)cc1] | CH₂SH | 0.8 1.0 | 0.30 0.96 |
| Z-2 | 89 | CH₃ | CH₂SH | 0.8 | 0.30 |
| | 19 | | | 1.0 | 0.99 |
| Z-3 | 97 23 | CH₂SH | 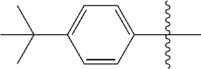 [SMILES: *c1ccc(C(C)(C)C)cc1] | 0.85 1.0 | 0.60^{c} 0.87^{c} |

^{a}The stoichiometry of the added β-lactam nucleophile relative to the moles of the co-initiator, which is supposed to be equal to the number of polymer chains.
^{b}The average number of C-terminal functional group per polymer chain, determined by Ellman's test.
^{c}Estimated by ¹H NMR.

The influence of structural parameters such as polymer length, composition end groups and subunit identity on the antimicrobial activity in solution was examined. Four different species were tested. It was revealed that antibacterial activities are not strongly affected by polymer length, in contrast to the hemolytic activity which is strongly influenced; higher molecular weight can increase hemolytic activity. The impact of end-group hydrophobicity was explored with a series of polymers. The increase in overall hydrophobicity of the polymers was established by longer end groups, containing N-terminal linear alkanoyl units from (C2) to (C18). Hemolytic activity was found to be more strongly affected by variations in N-terminal tail length than antimicrobial activity.

The term “tether” as used herein, is used interchangeably with the terms “spacer” or “arm” and refers to a molecule that is covalently attached to, and interposed between the polymer, or a linker attached thereto, and the membrane substrate or a linker attached thereto, as an alternative to direct attachment between the polymer and the membrane.

The tether molecule must have (before it is linked to the membrane) at least two terminal groups which are capable of linking to at least one polymer on one side and to the membrane on the other side, and the membrane and polymer must also have at least one such group each.

In particular, the tether should have at least two terminating groups, each being independently selected from a maleimide (MI) group, 6-aminohexanoic acid, a thiol group, an azide group, an amine group, a carboxyl group or an acetylene group.

Similarly, both the membrane and the polymer should also independently have at least one terminating group being selected from a maleimide (MI) group, 6-aminohexanoic acid, a thiol group, an azide group, an amine group, a carboxyl group or an acetylene group.

As discussed hereinabove, suitable covalent bonding between the tether and the membrane and/or the polymer include an amide bond, a thioether bond, a carbon-carbon covalent bond and a carbon-nitrogen bond. Therefore, some examples of suitable terminal groups include, but are not limited to, carboxyl (CO), amine, thiol and imides. In many examples a diamine tether or an amine-terminated and thiol-terminated tethers were used.

However additional attachment nay be based on other common chemical reactions. For example:
Click chemistry, which means coupling of azide group on one site, to an alkyne group on a second site (this method is applicable to membranes that are resistant to organic solvents, since it is performed in solvents such as toluence, tetrahydrofuran, dimethyl-sulfoxide, etc.).
“HydraLink”: It is based on a reaction between hydrazine and aldehyde: 2-hydrazinopyridyl moiety on one site, and a benzaldehyde moiety on second site.
Avidin/biotin: a ligation between biotin group (see draw) and avidin. Avidin is a protein which can be bound either via its amine or carboxyl groups. Biotin can be bound via its carboxyl group.

In all of these cases, the tether and/or membrane and/or polymer can be easily modified, mostly “off membrane” to introduce the suitable terminating groups into their respective positions, as known to a person skilled in the art.

Since each of the tether molecules is independently attached to the antimicrobial polymer and/or to the membrane via a bond selected from an amide bond, a thioether bond, a carbon-carbon bond, a carbon-nitrogen bond, an azide-alkyne bond, a hydrazine-aldehyde bond and an Avidin-biotin (host-guest) complexation, it can be seen that according to preferred embodiments of the invention, there is provided an antimicrobial water treatment membrane as described hereinabove, wherein:

i) the antimicrobial polymer has an IC₅₀ value of up to 200 μg/ml against at least one biofilm-forming microorganism; and

ii) each of the tether molecules is independently attached to said antimicrobial polymer and/or to said membrane via a bond selected from an amide bond, a thioether bond, a carbon-carbon bond, a carbon-nitrogen bond, an azide-alkyne bond, a hydrazine-aldehyde bond and an Avidin-biotin (host-guest) complexation.

Depending on the type of attachment of the polymer to the membrane, the tether molecule can be either short or long.

For example, according to one preferred embodiment of the invention, the membrane is attached to a single antimicrobial polymer chain, thereby forming a linear immobilized membrane.

According to another preferred embodiment of the invention, the membrane is attached to more than one antimicrobial polymer chain, thereby forming a multivalent immobilized membrane. Multivalent immobilized membranes are advantageous in that they provide a locally-rich environment of antimicrobial polymers in the final product due to high antimicrobial polymer loading on the membrane surface.

In most cases, both for linear and multivalent immobilized membranes, the tether is typically a molecule such as an oligomer or polymer, having a molecular weight (MW) of at least 300 grams/mol, but more preferably its molecular weight is higher, namely at least 500 grams/mol. Many useful tethers are found in the range of 500-2000 grams/mol. For example, it can be seen that the tethers used in the Examples section below included a long PEG arm, for example, such as PEG-diamine 2000 as well as PEG-diamines of between 800-7500 gr/mol may be used. According to another embodiment the tether includes a Jeffamine™ arm, typically, Jeffamine 300, Jeffamine 500, or Jeffamine 800.

In the multivalent one can use either long polymeric tethers as described above, or regular (small) molecules, such as butanediamine ethanediamine and hexanediamine, since the multivalent system has usually long arms already by itself. However, if another type of multivalent is used, which is smaller, such as small dendrimers, than long tethers should be used, as described hereinabove.

In particular for linear immobilized membranes, it has been further found that it is preferable that the tether forms a minimal distance between the membrane and the polymer. This minimal distance can be correlated to a maximal, or extended, length of the tether, in an aqueous solution environment being at least 1.5 nanometers long, more preferably at least 3 nanometers long, yet more preferably at least 5 nanometers long.

The term “extended length” (EL) refers to the theoretical maximal length of the polymer, in its stretched form, under aqueous conditions. It is calculated by molecular dynamics calculations.

For example, in the systems prepared in the Examples below, the calculated extended length was 27.3 nm for using PEG3000-diamine tether, 18.2 nm for using PEG2000-diamine tether, 5.1 nm for JeffAmine800 tether, 3.2 nm for JeffAmine500 tether, 1.92 nm for JeffAmine300 tether.

Yet further, it has been found that the ratio between the molecular weight and the extended (maximal) length of the tether, namely MW/EL, is preferably lower than 1,200 grams/mol per 1 nanometer.

For example, in the systems prepared in the Examples below, the calculated ratio between the molecular weight and the extended length was 172 grams/mol per 1 nm for the JeffAmine tether and ˜120 grams/mol per 1 nm for the PEG tethers.

Thus, according to a preferred embodiment of the present invention, there is provided an antimicrobial water treatment membrane comprising a water treatment membrane, covalently attached to one or more antimicrobial polymers or derivatives thereof via one or more tether molecules, wherein this tether:
is an oligomer or a polymer having a molecular weight (MW) of at least 300 grams/mol,
has an extended length (EL), in an aqueous environment, of at least 1.5 nanometers; and
has a ratio between said MW and said EL which is lower than 1,200 grams/mol per 1 nanometer.

While in most cases these tethers are synthetic polymers, they can also be bio-polymers, such as DNA, polysaccharides (and oligosaccharides), RNA, etc.

Examples of suitable tether polymers for both linear and multivalent immobilization, include, but are not limited to, Poly Ethylene Glycol (PEG), poly-acrylamide, poly-(D)-lysine, poly-methacrylic acid, or a co-polymer of methacrylic acid and other acrylate monomer, diamine polymers such as JeffAmine™, poly-maleic anhydride or copolymer of (ethylene) and (maleic anhydride), a lysine dendrimer or any other dendrimer and polyethylene-imine.

According to preferred embodiments of the invention, the tether molecule is selected from: a Poly Ethylene Glycol (PEG) polymer, water soluble polyethers that are derivatives of polyethylene-glycol, a poly-acrylamide polymer, a poly-(D)-lysine polymer, a polyacrylate, a diamine polymer and poly-(D)-Aspartic acid.

The tethers may themselves be multivalent molecules, such as polymers prepared by graft polymerization or branched polymers have a multitude of functional groups, to which the polymers or linkers may be later attached. Multivalent tethers are also advantageous in that they provide a locally-rich environment of antimicrobial polymers in the final product due to high antimicrobial polymer loading on the membrane surface.

The term “linker” is also referred to interchangeably by the term “linking group” or “binding group” and is typically a small molecule containing a suitable binding group. However, the term also encompasses the binding group itself as a chemical group. Some preferable examples of suitable linkers include, but are not limited to molecules including a maleimide (MI) group, 6-aminohexanoic acid, amine, thiol, or azide. Furthermore, suitable linkers may contain an acetylene group to allow, for example, “click chemistry” attachment.

According to one embodiment of the invention, a linker (such as maleimide) is attached via a small molecule (such as 2-amino-ethyl-maleimide) to the membrane. Branched linkers may be used during this step (for example Bis-Mal-Oc-NH₂). Other branched linkers, such as commercially available dendrimers with appropriate end groups, may be used.

The use of branched linkers may enhance polymer concentration on the membrane. In this case, a polymer is attached to a tether (such as a PEG molecule) off-membrane. Typically, the tether has a binding group (e.g., thiol) at its end to enable attachment to the linker which is immobilized to the membrane. The polymer with a thiol-tether at one side is then attached to the maleimide on the membrane. According to other embodiments, instead of maleimide-thiol chemistry the linker may be based on click chemistry, for example, using an acetylene and azide group linkers.

It should be noted that a modified tether, such as a tether attached to a linking group or binding group, as described herein, will typically remain a “tether” as per the definitions provided hereinabove. For example, a PEG tether attached to an MI linker is also defined as a tether for the purpose of this invention, since it remains a polymer or oligomer, having the minimal molecular weight (MW) of 300 grams/mol, as long as it still follows the requirements of a minimal extended length (EL) and a maximal MW/EL ratio.

Thus, it should also be clarified that the polymers or oligomers comprising the tether may be homopolymers and copolymers of all sorts, and may include blocks of oligomers and/or or blocks of polymers linked by one or more linking groups, as suggested herein.

Some additional preferred embodiments of the invention include the following specific antimicrobial water treatment membranes, prepared by the inventors as described herein, having structures I-III shown below, wherein for each structure j, k, l, m and n are integers independently chosen to be larger than 1, and the polymer is selected from:

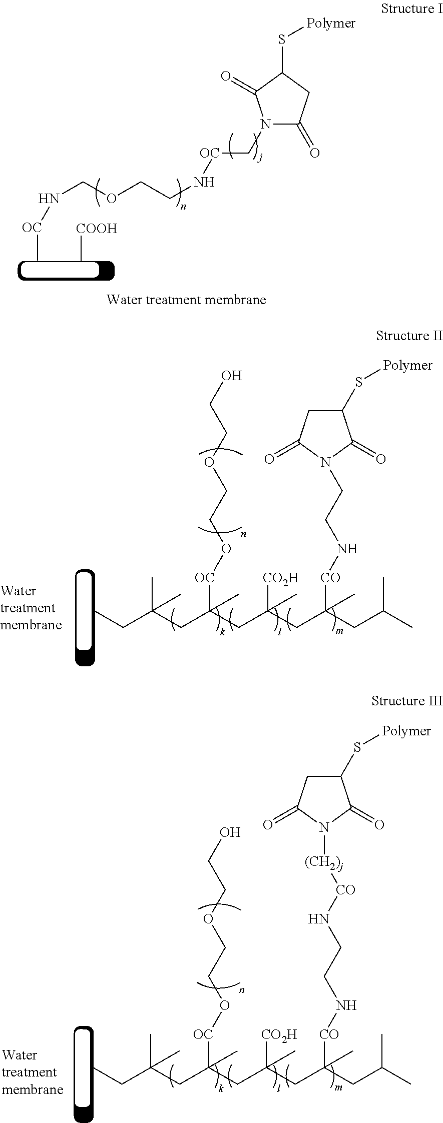

Wherein j, k, l, m and n are integers independently larger than 1, and the polymer is selected from polylactams, poly-amino acids and polymers containing tertiary and/or quaternary ammonium groups.

As can be seen in the experimental section which follows, RO membranes having polymers immobilized thereon via tethers showed reduced biofilm formation on the membrane surface in comparison with membranes not having immobilized polymers.

For example, Biofilm growth inhibition measurements of membranes immobilized with antimicrobial polylactams were performed in static conditions system in the lab using Klebsiella oxytoca as well as in flow cell conditions using P. aeruginosa by the group of Dr. Ehud Banin at Bar-Ilan University. Biofilm growth on the membrane modified with antimicrobial polylactams by the linear procedure measured in flow cell system biofilm growth showed was mostly reduced (0-25% lower) in comparison to unmodified membranes. When immobilizing antimicrobial polylactams Z-2, Z-3 and Z-4, through the multivalent procedure, biofilm growth measurements in static conditions showed a reduction of 25%-60% in biofilm formation as compared to the unmodified membrane; measurement of biofilm growth in a flow cell system showed that polymers excluding Z-1, Z-2 and Z-3 showed a reduction of 25%-50% as compared to unmodified membrane.

It is therefore clear that the present invention provides both novel membranes and a method for water treatment using these polymer immobilized membrane to avoid biofouling during water treatment processes.

Thus, according to another aspect of the invention, there is provided an antibacterial membrane as described hereinabove, for use in water purification, sea-water desalination, waste water treatment, brackish water treatment, industrial water treatment and water recycling.

In particular, since it has been shown by the inventors that the attachment of the polymer to the membrane is preferably done via a tether, there is provided a process for preparing an antimicrobial water treatment membrane, this process comprising covalently attaching one or more antimicrobial polymers or derivatives thereof to a water treatment membrane, via a tether molecule.

The tether and the polymer are as defined hereinabove.

As noted above, the one or more antimicrobial polymers have a very low IC₅₀, and were covalently attached to the membrane, either directly or via a tether and/or linker molecules to obtain the antimicrobial membranes described herein. It has been further shown that the tether molecule must have at least two suitable terminating groups, and that both the polymer and the membrane must also have suitable terminating groups, to enable the desired covalent linking between the membrane, the tether and the antimicrobial polymer.

Thus, according to an additional aspect of the invention, there is provided a process for preparing an antimicrobial water treatment membrane, this process comprising immobilizing one or more antimicrobial polymers or derivatives thereof on a water treatment membrane, by covalently attaching the polymer and the membrane via one or more tether molecules, wherein:

i) the tether molecule has at least two terminating groups, each being independently selected from a maleimide (MI) group, 6-aminohexanoic acid, a thiol group, an azide group, an amine group, a carboxyl group or an acetylene group;

ii) the membrane and said polymer independently have at least one terminating group being selected from a maleimide (MI) group, 6-aminohexanoic acid, a thiol group, an azide group, an amine group, a carboxyl group or an acetylene group; and

iii) the antimicrobial polymer has an IC₅₀ value of up to 200 μg/ml against at least one biofilm-forming microorganism.

It is important to note that the according to a preferred embodiment of the invention, the preparation of the antimicrobial polymer and/or the modification of the polymer is conducted “off membrane”.

According to another preferred embodiment of the invention, the process is conducted at a temperature ranging from about 15° C. to about 40° C.

The pH may be controlled as known to any person skilled in the art, in line of the general synthetic steps outlined below, but may be modified as needed.

In order to obtain the antimicrobial water treatment membranes of the present invention, there are several synthetic routes, but all are based on covalently attaching one or more antimicrobial polymers to a water treatment membrane, optionally via a tether molecule and/or via a linker attaching the polymer to the tether or/linker or attaching the tether/linker to the membrane surface.

More specifically, as detailed below, the preparation of the modified antibacterial water treatment membranes can be affected by one of several routes, some of which are detailed below:
a) Attaching an antimicrobial polymer (Pol) directly to a water treatment membrane (M) to obtain a (Pol-M) modified antimicrobial membrane;
b) Attaching the tether (T) to a water treatment membrane (M) to obtain a membrane-tether (M-T) moiety, and then attaching the antimicrobial polymer (Pol) to the membrane-tether moiety to obtain a (POL-T-M) modified antimicrobial membrane;
c) Attaching an antimicrobial polymer (POL) to a linker group (L) to obtain a polymer-linker (POL-L) moiety and then attaching the linker-polymer moiety to the membrane (M) to obtain a (POL-L-M) modified antimicrobial membrane;
d) Attaching an antimicrobial polymer (POL) to a linker (L) to obtain a polymer-linker (POL-L) moiety, then attaching it to a tether (T) to obtain a polymer-linker-tether (POL-L-T) moiety, and then attaching this moiety to a water treatment membrane to obtain a (POL-L-T-M) modified antimicrobial membrane;
e) Attaching the antimicrobial polymer (POL) to a linker (L) to obtain a polymer-linker (POL-L) moiety, while separately attaching a tether (T) to a water treatment membrane (M) to obtain a membrane-tether moiety (M-T), and then attaching the polymer-linker moiety to the membrane-tether moiety to obtain a (POL-L-T-M) modified antimicrobial membrane;
f) Attaching the tether (T) to a water treatment membrane (M) to obtain a membrane-tether (M-T) moiety, then attaching a linker (L) to the membrane-tether moiety to obtain a membrane-tether-linker (M-T-L) moiety, and then attaching the antimicrobial polymer (POL) to the membrane-tether-linker moiety to obtain a (POL-L-T-M) modified antimicrobial membrane; or
g) Attaching a linker (L) to a water treatment membrane (M) to obtain a membrane-linker (M-L) moiety, then attaching a tether (T) to the membrane-linker moiety to obtain a membrane-linker-tether (M-L-T) moiety, then attaching it via another linker (L) to an antimicrobial polymer (POL) to obtain a (POL-L-T-L-M) modified antimicrobial membrane.

In each of these cases the linker may be linear or branched, and the tether may be single valent or multivalent.

For further clarity, it should be emphasized that the moiety POL-L can be regarded as a modified polymer, that the moiety M-L can be regarded as a modified membrane, that the moiety T-L can be regarded as a modified tether and that the moiety T-POL can be defined as a tethered POL.

As shown in the experimental section below, four antimicrobial polylactams were immobilized to FILMTEC LE-400 brackish water RO membranes by using either a three-stage procedure for the linear method or a four-stage procedure for the multivalent method. In both methods the attachment of antimicrobial polylactams was preferably accomplished via a tether.

For example, as shown below, the tether can be a specific maleimide (MT) and the linking is based on a MI-thiol chemistry.

In this case, prior to the polylactam immobilization, the MI molecule was bounded to the membrane surface through a long polymeric arm either directly to the functional groups located on the TFC membrane or through polymer brushes established by graft polymerization of methacrylic monomers.

As explained hereinabove, linear immobilization is one way of linking the antimicrobial polymers and the membrane. It is illustrated, in one exemplary embodiment, in Scheme 5 below.

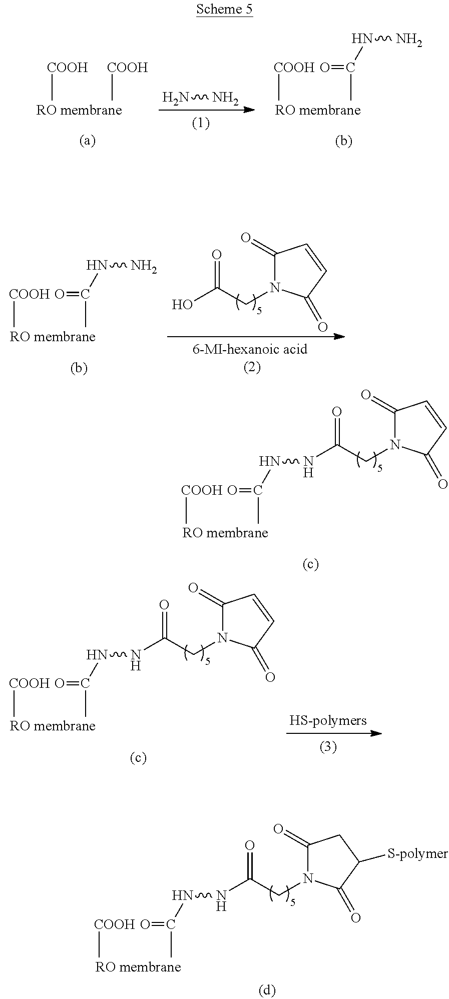

Schematics of synthetic procedure of linear immobilization of antimicrobial polymers on RO membranes. Reagents and conditions: (1) 20 mM EDC, 20 mM sulfo-NHS, 60 mM diamine tether (Jeffamine500) in 100 mM sodium phosphate buffer pH 7.4, overnight; (2) 20 mM 6-maleimidohexanoic acid, 20 mM EDC, and 20 mM sulfo-NHS in 100 mM sodium phosphate buffer at pH 7.4 overnight; (3) 1-2 mM antimicrobial polymer in 100 mM sodium phosphate pH 7.4, overnight.

As shown in Scheme 5, the linear immobilization is carried out in three successive steps using a tether, such as a Jeffamine as a polymer tether in aqueous solution: In step (1) Jeffamine is coupled through an amide bond with the carboxyl groups of the aromatic polyamide RO membrane using N-(3-dimethylaminopropyl) carbodiimide (EDC) and N-Hydroxysuccinimide (NHS) chemistry. In step (2), 6-maleimide hexanoic acid (MI hexanoic acid) is coupled to the tether-amine on the membrane. In step (3) the maleimide (MI) group is bound to the antimicrobial polymer via a thiol group which is located at the amine or carboxyl terminal of the polymer through specific maleimide-thiol chemistry. The thiol group was introduced to the polylactams at the end of polylactams synthesis; it is located at the C-terminal in polymers Z-1 and Z-2, N-terminal in Z-3 and Z-4 (see Scheme 6 below). All the reactions are conducted in sodium-phosphate buffer (pH=7.4).

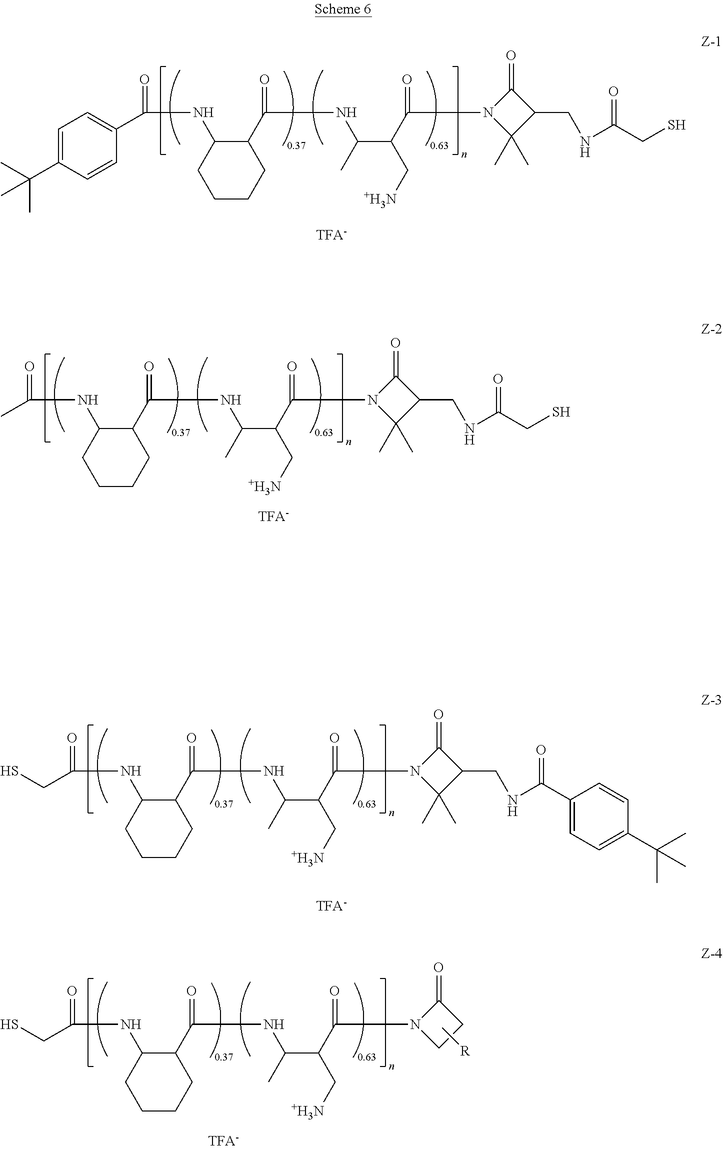

Thus in a more general manner, according to another embodiment of the invention, the process described herein discloses:
a) attaching at least one diamine tether to the membrane to obtain a tethered membrane;
b) attaching a maleimide (MI) linker to the tethered membrane to obtain an MI-linked-tethered membrane; and
c) attaching at least one antimicrobial polymer containing a thiol side group to the MI-linked-tethered membrane to obtain an antimicrobial polymer linearly immobilized on the membrane.

As a high local concentration of the antimicrobial polymers on bacterial membrane is required for the lethal effect of the polymers, an increase of local concentration of the polymers was now achieved by the inventors by multivalent immobilization of polymers on RO membranes, using two approaches: By graft polymerization, and by dendrimers or multifunctional polymers, as shown in scheme 7, in comparison to linear immobilization.

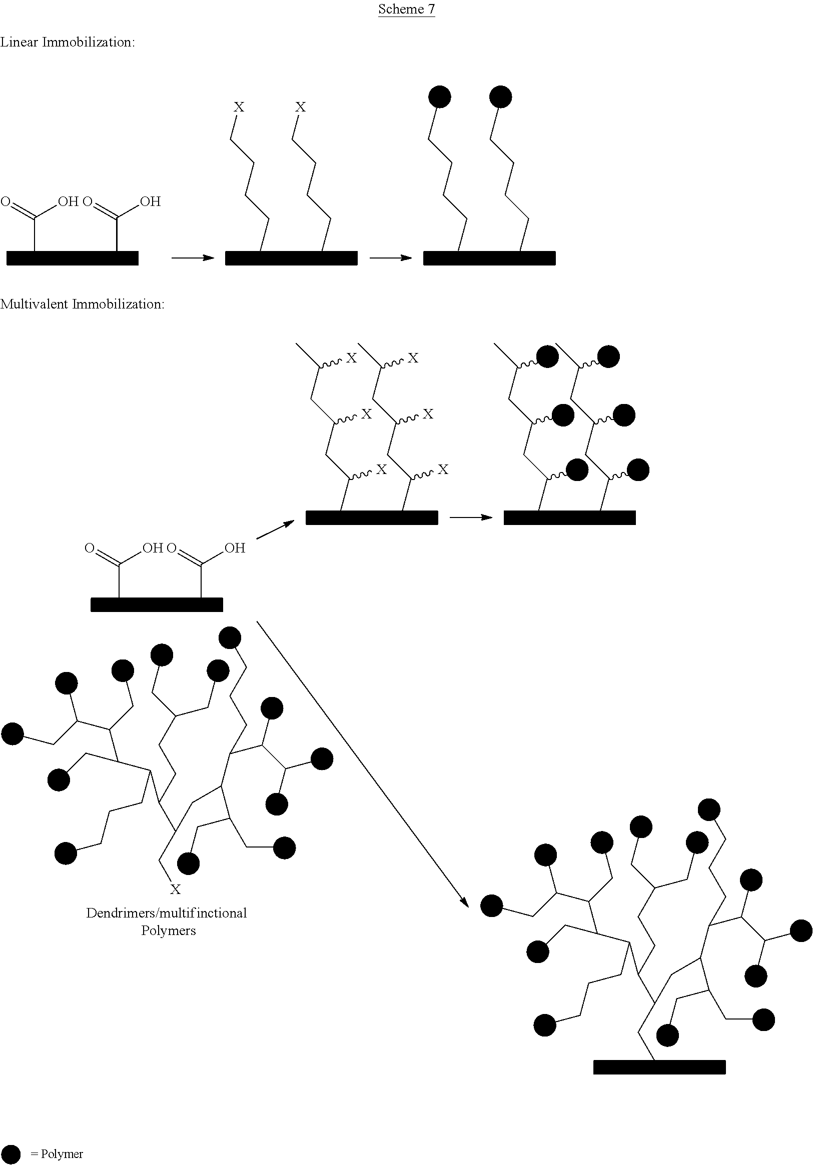

Thus, according to preferred embodiments of the invention, the process described herein further comprises graft polymerizing monomers present on said membrane, prior to said immobilizing, wherein said polymerizing is conducted in the presence of at least one initiator, thereby obtaining an antimicrobial polymer multivalently immobilized on said membrane.

The term “Graft polymerization” as used herein, refers to a polymerization process conducted on a surface, whereby the initiation is conducted on the surface. It has been described, on membranal surface, e.g. in Belfer, et al. (1998) (Journal of Membrane Science, 139, 175-181) to be used to obtain multi-arms molecular systems on the water treatment membrane, which has multiple copies of a functional group such as carboxyl, amine, thiol, ether or hydroxyl. This system may further be used to attach linkers to membranes. Graft polymerization may be used advantageously for attaching linkers to the membrane in a branched manner, hence multiple copies manner.

The graft polymerization can be conducted on a polyethersulfone membrane, polyacrylonitrile (PAN) UF membranes and Cellulose Acetate membranes.

The graft polymerization is often initiated by a redox initiation system. For example, the polymerization may be initiated by a reaction of the redox initiators K₂S₂O₅ and K₂S₂O₈ to form free radicals both on the polymeric surface of the membrane and in solution.

However, other initiator systems may be used, as known to any person skilled in the art. For example: UV-radiation, ionizing radiation, oxidation by ozone, low-temperature plasma.

A large number of monomers can be used in a graft polymerization process whereas the most suitable are commercially available monomers that can be polymerized in aqueous solutions by known procedures, such as acrylate- and methacrylate-derivatives. Preferably, the monomers are selected from the group comprising of acrylate- and methacrylate-derivatives, maleic anhydride, ethylene, ethylene-glycol derivatives vinyl-pyrrolidone, vinyl-derivatives that have carboxyl or amine groups, and styrene derivatives.

Some preferred monomers are listed in Scheme 8 below:

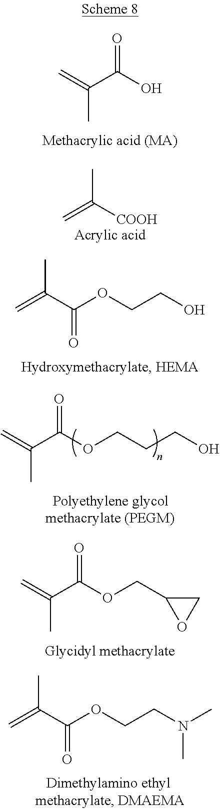

In the present invention, methacrylic monomers were used for graft polymerization and attachment of the antimicrobial polymers to the surface of RO membrane. MA was chosen as a representative compound of acrylic monomers having charged groups and PEGMA as a representative of oxyethyleneglycols that are widely known to reduce protein adsorption.

Examples of methacrylic monomers which were used for graft polymerization of RO membranes are: (A) methacrylic acid (MA) and (B) polyethylene glycol methacrylate (PEGMA) depicted in Scheme 9 below.

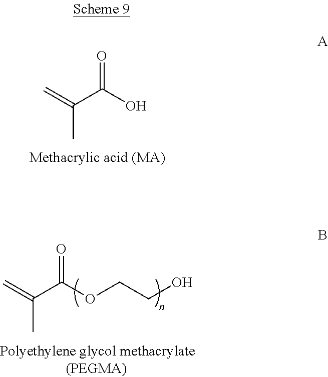

Therefore, according to one preferred embodiment of the invention, the monomers are methacrylate monomers.

The term “methacrylate monomers” is generally understood to mean esters of methacrylic acid and aliphatic, cycloaliphatic, and aromatic alcohols, whereby the esters can also be formed with dialcohols, trialcohols or other polyalcohols. The most significant representative of these monomers is methylmethacrylate. The term, methacrylate monomer, is also understood to include methacrylic acid amide and singly N-substituted or doubly N,N-substituted methacylic acid amides.

An exemplary graft polymerization process, conducted in situ on an RO polyamide membrane, using the Methacrylic acid (MA) and Polyethylene glycol methacrylate (PEGM) monomers using redox-initiated graft-polymerization technique is depicted in scheme 10 below:

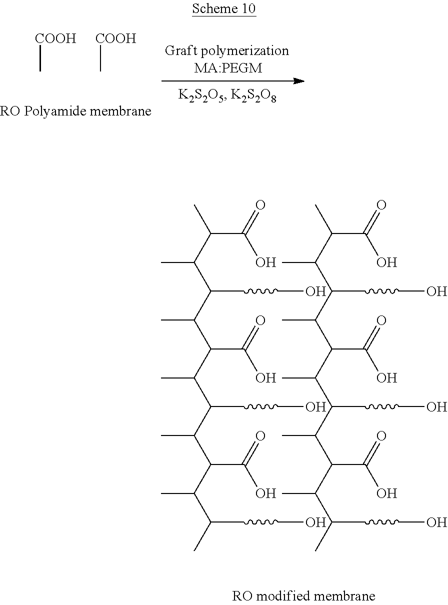

Once the graft polymerization has been conducted on the membrane, the attachment of the tether and/or linker and subsequently the antimicrobial polymer(s) can follow, in scheme 11 or more efficiently in Scheme 12.

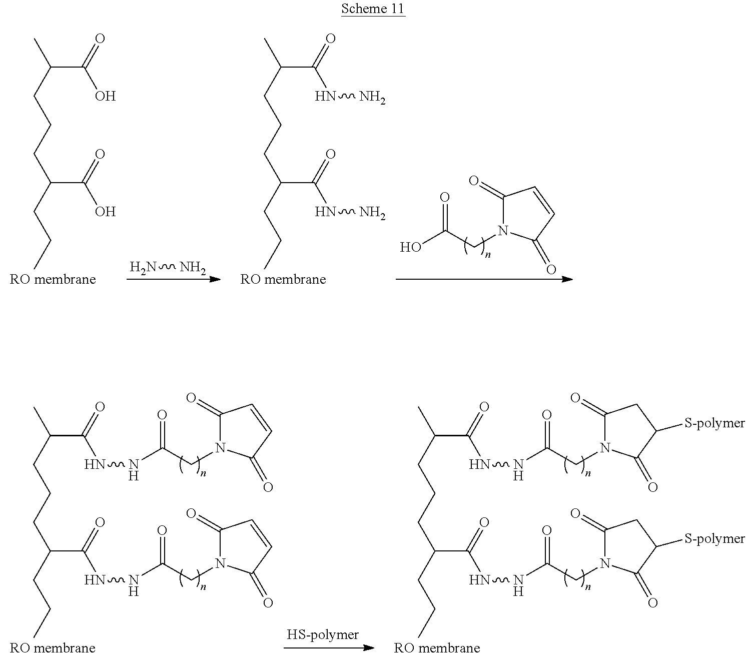

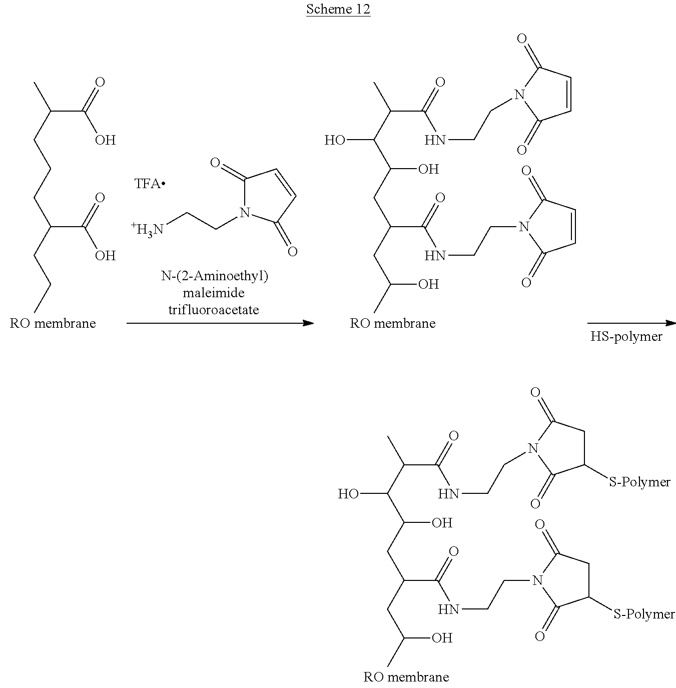

One such complete synthesis is depicted in Scheme 13, which shows one exemplary attachment of polymers to a tethered RO membrane using a multivalent system via Redox initiated graft polymerization.

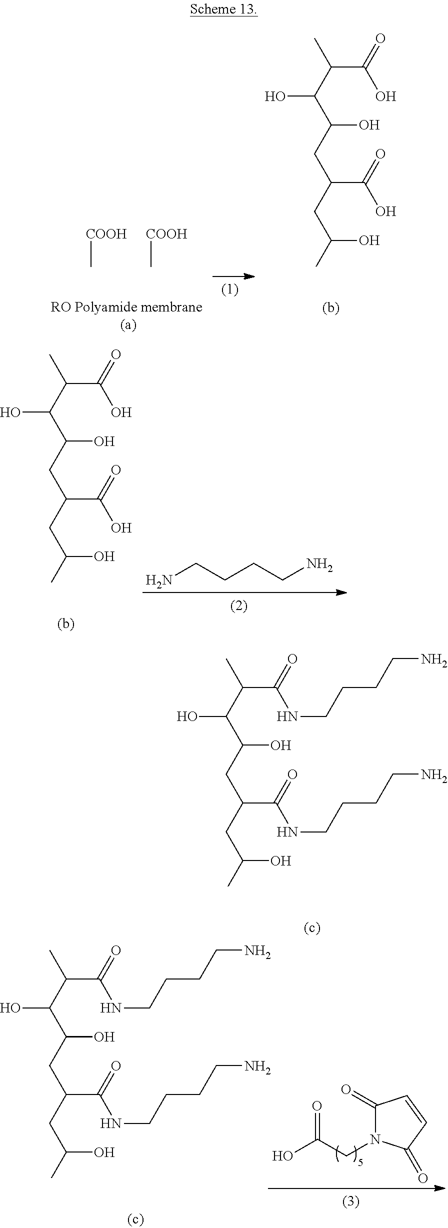

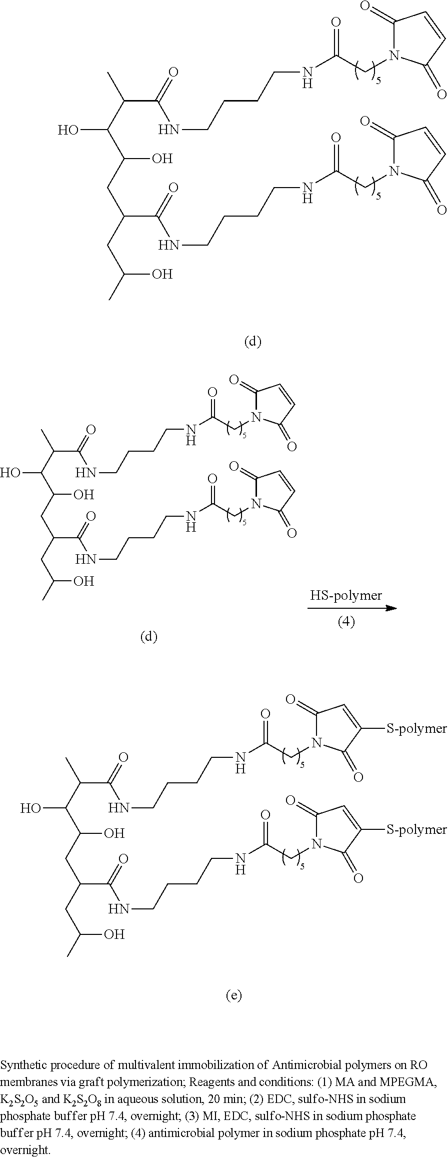

Another method for multivalent-immobilization is proposed, in which amino maleimide (MI) linker is used, such as amino-ethyl maleimide, as described in Scheme 14. The number of synthetic steps on the membrane is reduced from 4 to 3, thereby increasing the yield. Such an “efficient method” was described also for the linear polymer immobilization scheme, by the use of amino-alkyl-s.

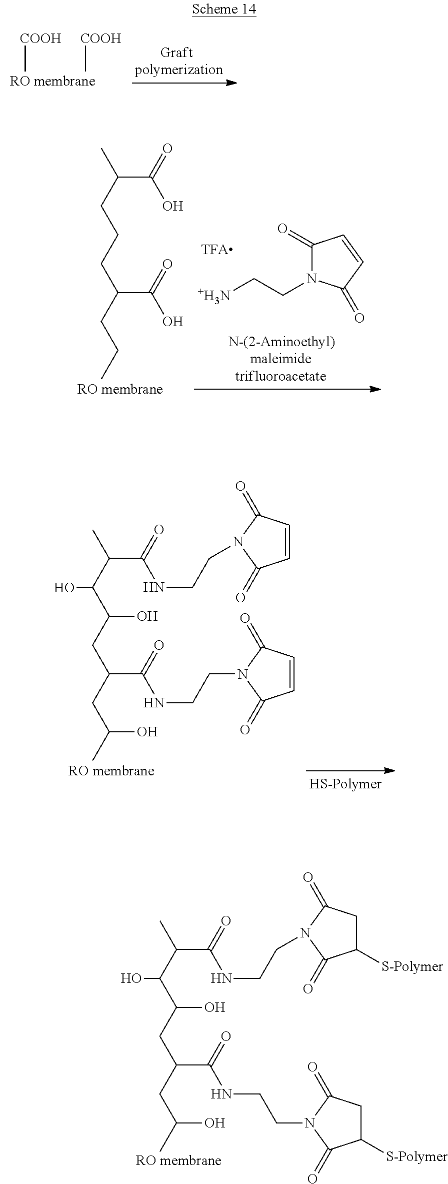

Scheme 15 presents examples of immobilization types of antimicrobial polymers on RO polyamide membranes through maleimide linker:

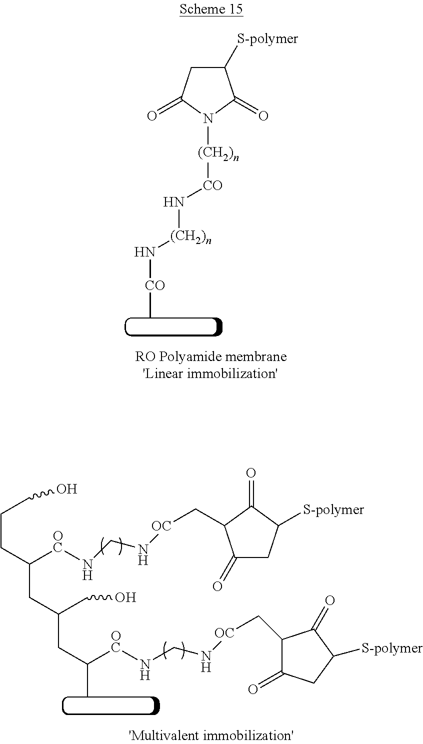

An alternative process for the preparation of multivalent systems is through the use of dendrimers. An example for immobilization of polymers through multivalent system by use of dendrimers is shown in Scheme 16.

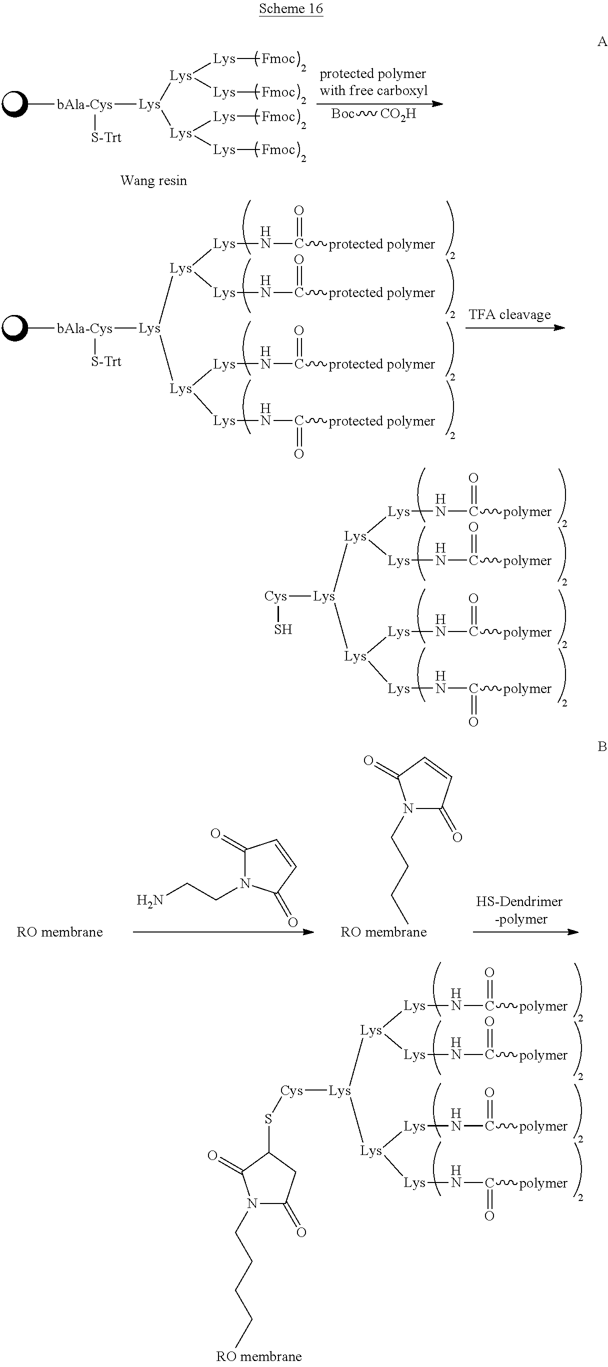

Multifunctional polymers may also be used to immobilize polymers to RO membranes in multivalent system. In the first stage a polymer conjugated to multiple copies of an antimicrobial polymer is created. In the second stage binding the polymer conjugate to the RO membrane surface is done as was described for dendrimers in Scheme 17.

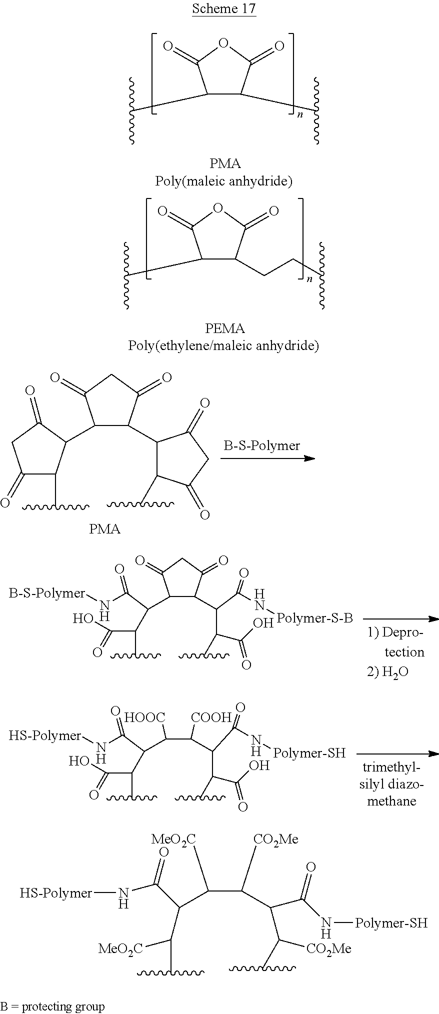

The experimental methods that were described for immobilization of antimicrobial polymers on water treatment membranes represent a novel strategy for coping with biofilm growth on surfaces in water technologies; inhibition of biofilm growth on such surfaces, especially RO and NF membranes, will increase their life time, and eventually will lead to lower costs of water treatment.

Thus, according to another aspect of the invention, there is provided the an antimicrobial water purification process, comprising contacting a water source selected from sea-water, waste water, brackish water, industrial water, irrigation water and drinking water, with an antimicrobial water treatment membrane according to the present invention, as described hereinabove.

For more information on membranes for RO, uses and modes of application thereof see: Petersen, R. J. (1993) Journal of Membrane Science 83, 81-150; and R. Kasher. Membrane-based water treatment technologies: Recent achievements, and new challenges for a chemist. Bulletin of the Israel Chemical Society|Issue No. 24, December 2009.

For more information on water treatment by membranes, see: Advanced Membrane Technology and Applications. Norman N Li (Editor), Anthony C. Fane (Editor), W. S. Winston Ho (Editor), Takeshi Matsuura (Editor). John Wiley and Sons, New Jersey (2008).

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### Experimental Section

Reference is now made to the following examples, which together with the above descriptions, illustrate the invention in a non limiting fashion.

### Materials

6-Maleimidohexanoic acid (MI-hexanoic acid) and coupling reagents were purchased from Chem-Impex International (Wood Dale, Ill.). O,O′-Bis(2-aminopropyl)polypropylene glycol (Jeffamine300), O,O′-bis(2-aminopropyl)polypropylene glycol-block-polyethylene glycol-block-polypropylene glycol of MW 600 (Jeffamine500), MA, poly(ethylene glycol) methacrylate (PEGM), crystal violet and toluidine blue were purchased from Sigma-Aldrich (St. Louis, Mo.). Potassium persulfate (K2O8S2), potassium metabisulfite (K2S2O5) were purchased from Acros organics (Geel, Belgium). Tryptic Soy Broth (TSB) was purchased from Acumedia Manufacturers (Lansing, Mich.). RTV 186 was purchased from Polymer G'vulot (Kibbutz G'vulot, Israel). Flat-sheet low-energy brackish water LE-400 high-productivity RO membranes were provided as a gift from the FILMTEC Membranes Dow Water Solutions (Midland, Mich.).

### Methods and Analysis

### ATR-FTIR Analysis

Attenuated total reflection fourier transform infrared (ATR-FTIR) spectroscopy measurements were recorded on a Vertex 70 FTIR spectrometer (Bruker Optiks, Ettlingen, Germany) using a Miracle ATR attachment with a one-reflection diamond-coated KRS-5 element. The resulted spectra were manipulated using the OPUS softwear, version 6.5 for spectral analysis, by BRUKER Optiks GmbH, Ettlingen, Germany. The tested membranes were dried overnight under vacuum prior to the measurement. In order to evaluate the grafting density, a method of approximation was used where a peak intensity ratio of an analytical peak (absorbance of a new peak) to a peak typical to the pristine membrane was calculated and taken as measure of grafting. Usually in RO membranes the intensities of esteric carbonyl (1720 cm⁻¹) and of membrane amide peak (1488 cm⁻¹) were taken as estimation of grafting density.

Wettability Measurements of RO Membranes

RO membranes (usually 1×2 cm²) were washed and modified as described hereinbelow. The hydrophobicity of the tested membrane was determined by the sessile drop method or by the captive bubble method using an OCA-20 contact angle analyzer (DataPhysics, Filderstadt, Germany) equipped with a video camera, image grabber and data analysis software. In the sessile drop method, the membranes were dried overnight under vacuum at room temperature. A drop of water was introduced by injecting 0.5 μL DI water, an average of at least 7 drops was used to characterize each membrane sample. In the captive bubble method, the membranes were kept in water after modification. In this method, heptane drop touches the membrane surface that is immersed in DDW. The angle that was measured was the outer angle. Since the heptane bubble is considered the hydrophobic element, a higher contact angle would represent a more hydrophobic surface and vice versa. This method allows for more robust results regarding the wettabilities of modified membranes in typical working conditions.

Toluidine Blue (TB) Test for Membrane Modification Yield (Determination of Carboxylic Groups on RO Membranes):

The test measures the carboxyl group concentration on the surface of the membrane, and was used to estimate the degree of modification. The test was based on the published article by Nakajima et al. 1995 [Nakajima, N. 1995, Bioconjugate chemistry, vol. 6, no. 1, p. 123] with various modification; the membranes were glued to glass slides using RTV 186 glue (prepared according to manufacturer instructions—Polymer G'vulot). Toluidine blue (0.5 mM in NaOH solution, pH=10) was added to the membranes and agitated for 3 hours. The membranes were rinsed with NaOH solution pH=10 until the rinsing solution was completely colorless (normally 8-10 times, 5 minutes each). The dye was eluted with minimal volume (12-13 ml) of 50% (v/v) acetic acid for 2 hours. The absorbance of the dye was measured at 633 nm (Lambda EZ 201 PerkinElmer spectrophotometer, Waltham, Mass.). For reference, a 50% acetic acid solution was used. To determine the surface concentration of carboxyl groups an absorbance calibration curve was constructed using the following TB concentrations (in 50% acetic acid): 5 μM, 4 μM, 3 μM, 2 μM, 1 μM and 0.5 μM at 633 nm. The surface concentration of the acid groups was calculated based on the membrane area, dye concentration, and volume of the eluting solution. The concentration of carboxyl groups on membrane surface was calculated with the assumption of 1:1 dye:carboxyl group complex.

Initially, the concentration of carboxyl groups on the surface of 3 different RO membranes was estimated using Toluidine blue adsorption: ESPA1, FILMTEC SW30HR LE-400, and FILMTEC LE-400 (brackish water). The results are presented in Table 2.

TABLE 2

| | Membrane | | COOH | COOH surface |
|---|---|---|---|---|
| RO | area | Absorption | concentration | concentration^{a} |
| membrane | [cm²] | (633 nm) | [M] | [mol/cm²] |
| ESPA1 | 12.0 | 0.850 | 2.28 × 10⁻⁵ | 2.28 × 10⁻⁸ |
| FILMTEC | 19.8 | 0.534 | 2.86 × 10⁻⁵ | 1.74 × 10⁻⁸ |
| LE-400 | | | | |
| FILMTEC | 12.0 | 0.278 | 7.43 × 10⁻⁶ | 7.43 × 10⁹ |
| SW30HR | | | | |
| LE-400 | | | | |

^{a}V = 12 ml

### Biofilm Growth Measurements on RO Membranes in Flow Cell

Biofilm growth on RO membranes was measured by the lab of Dr. Ehud Banin from Faculty of Life Sciences, Bar-Ilan University. Biofilm growth of Green Fluorescent Protein (GFP) expressing Pseudomonas aeruginosa was measured in a flow cell and quantified by confocal laser scanning microscope (CLSM).

### Analysis of Biofilm Growth on RO Membranes in Static Conditions Using Viable Count

RO membranes (1.5×0.8 cm²) were glued to slides and were washed and immobilized with antimicrobial polymers as described in section Example 1. The membrane slides were washed in 70% ethanol followed by washing with sterile DDW. Klebsiella oxytoca culture (20-30 ml) was grown in Tryptic Soy Broth medium (TSB; prepared according to manufacturer instructions) at 25° C. for 18-20 h. The culture turbidity was measured at 600 nm using a Biomate 5 UV-Vis spectrophotometer (Thermo Fisher Scientific, Waltham, Mass.) and if necessary, TSB was added to dilute the culture to OD=1. Then to each well in 24 wells cell culture plate (flat bottom, corning-costar, Cambridge, Mass.) 1.8 mL of TSB and 200 μl of Klebsiella oxytoca culture were introduced to reach a concentration of 10⁷ cells/ml. In each well glass-glued RO membrane was placed in a vertical position. Negative control wells were filled with 2 ml of TSB only. The membranes were incubated for 1 h in 25° C. and then were gently transferred to new wells containing 2 ml fresh TSB for 6 h incubation. The membranes were transferred to new wells containing fresh TSB two additional times with 6 h and 12 h incubation times. Then, each membrane was washed with 100 mM NaCl solution to remove the planktonic cells and placed in polystyrene tube containing 2 ml sterile PBS buffer. The membranes were sonicated for 30 seconds in order to detach the biofilm from the membrane surface, and vortexed for a few seconds to further facilitate removal. Subsequently, for each solution serial dilutions were made by a factor of 10³ in PBS buffer. Form each diluted sample a drop of 10 μl was placed on TSB agar plate. All assays were carried cut in four replications with an average of 10 drops for each membrane sample. After incubation of 12 h at 25° C. live bacteria were counted and colony forming units (CFUs) per area of membrane were calculated.

Calibration Curve for Klebsiella oxytoca

Klebsiella oxytoca culture (50 ml) was grown in Tryptic Soy Broth medium (TSB; prepared according to manufacturer instructions) at 25° C. for 18-20 h. The bacteria culture was rinsed and centrifuge (Sigma 4k15) for 10 minutes in a cooling centrifuge at 6,000×g and 4° C., for the separation of the growth medium. Afterwards, the supernatant was discarded and the obtained pellet was carefully resuspended in 100 mM NaCl. This cycle was repeated two more times. A set of six serial dilutions by the factor of 10 were performed from original culture. The absorbance of each dilution was measured at 600 nm on Lambda EZ 201 Perkin-Elmer spectrophotometer (Waltham, Mass.). Then, all the dilutions higher than 10-6 were farther diluted to reach a final dilution of 10-6. 100 μl from each final dilution was plated and incubated for 24 h at 25° C. CFUs were counted and cell concentration was calculated and plotted versus the absorbance.

### Biofilm Growth Measurements on RO Membranes in Static Conditions

Evaluation of biofilm growth on membrane immobilized with antimicrobial polylactams by the multivalent procedure was conducted in static conditions followed by bacterial count as described hereinbelow. Nested ANOVA was used to test differences in colony forming unit (CFU) per area of membrane by comparing membranes immobilized with different polymers.

Quantification of microorganisms attached to surfaces is a recurring problem that has still not been completely resolved. The approach taken in this study was based on biofilm growth, then removal of bacteria from the membrane, followed by agar plating and viable count. One method to detach microorganisms from surfaces is the use of ultrasound. It was demonstrated that the bacteria numbers determined by sonication followed by plating is in agreement with the numbers determined by other methods such as direct staining of attached bacteria. Based on these findings, in order to quantify biofilm formation on RO membranes modified with nylon-3 copolymers, a quantitative procedure was developed based on sonication treatment followed by plate count.

Using sonication in order to detach the bacteria from the surface may have lethal effect on the bacteria and therefore we chose to use a short duration of 30 seconds. RO membranes were incubated in a 24 wells cell-culture plate with Klebsiella oxytoca culture. In order to avoid unspecific deposition of bacteria the membranes were placed in the wells in vertical state. The membranes were transferred several times to new wells containing sterile growth medium in order to allow biofilm to grow on the membrane surface. Followed incubation, the membranes were washed and placed in PBS buffer, sonicated, diluted and inoculated in agar plates as illustrated in FIG. 6. CFOs were counted and calculated in respect to membrane area.

FIG. 6 presents a Scematic drawing of biofilm quantitative experiments on RO membranes conducted in a 24-wells cell culture plate.

The use of this method for the quantification of biofilm formation on the surface relays on the basic assumption that the removal of the bacteria by sonication is not affected by the membrane modification.

### Statistical Analysis

Statistical analysis of biofilm quantification by viable bacteria count was done by nested analysis of variance (Nested ANOVA) with the treatment as fixed factor, and replication of each treatment level as a random factor nested within the treatment. For experiments in which there was only one control treatment, one-way ANOVA was used to test for differences between replications. Shapiro-Wilk and the Levene tests were used to test for normal distribution and homogeneity of variances. Whenever one or both of the assumptions were violated a logarithmic transformation was done. Dunnett post hoc test was used to rank the differences between the treatment groups. Means are presented ±SD. All statistical tests were done using STATISTICA 10.0.

### General Synthesis Methods

### Preparation of Antimicrobial Polymers:

Antimicrobial polymers were synthesized by Dr. Jihua Zhang at the group of Prof. Samuel Gellman (University of Wisconsin-Madison).

All chemicals for the preparation of the antimicrobial polymers were purchased from Aldrich (Milwaukee, Wis.), Acros Organics or TCT America, and used as received, unless stated otherwise.

β-Lactams “CH” and “MM” were synthesized by previously reported procedures (Mowery B P, Lee S E, Kissounko D A, Epand R F, Epand R M, Weisblum B, et al. Mimicry of antimicrobial host-defense polymers by random copolymers. J. Am. Chem. Soc. 2007; 129(50):15474-15476). Co-initiator I was synthesized according to the procedure reported by Lee et al. (JACS 2009, 131, 16779-16789). The synthesis of β-lactam nucleophiles “A” and “B” involved standard methods. ¹H spectra were recorded on Bruker AC-300 spectrometers at 300 MHz. The number-average molecular weight (Mn), weight-average molecular weight (Mw) and polydispersity (PDI=Mw/Mn) were obtained using a gel permeation chromatography (GPC) instrument equipped with a Shimadzu LC-10AD liquid chromatography (HPLC) pump and a Wyatt Technology miniDAWN multi-angle light scattering (MALS) detector (690 nm, 30 mW) in series with a Wyatt Technology Optilab-rEX refractive index detector (690 nm) using do/dc=0.1. All measurements were performed using two GPC columns (Waters Styragel HR4E) with THF as mobile phase at a flow rate of 1.0 mL/minutes at 40° C. The data were processed using ASTRA 5.3.2.15 software (Wyatt Technology).

### General Procedure of Preparation of 37:63 CH:MM Random Copolymers:

In a N₂-purged dry box, a mixture of CH and MM with a 37:63 molar ratio was prepared and placed in a reaction vial with a magnetic stirring bar. Then the appropriate type of co-initiator and anhydrous THF were added to achieve the desired monomer to co-initiator ratio ([CH+MM]₀/[I]₀=20) and monomer concentration (0.1 M). The polymerization was started by addition of a LiN(SiMe₃)₂ solution (2.0 eq. relative to [I]₀) in THF. After 10 minutes of the polymerization, the reaction was quenched by addition of methanol. The resulting polymer was precipitated by pouring the reaction solution into pentane. The precipitate was collected by centrifugation. The precipitate was then re-dissolved in CHCl₃ and re-precipitated by pouring this solution into pentane. This dissolution-precipitation process was repeated two more times, and the resulting polymer was dried under N₂ stream.

### General Procedure of C-Terminal Functionalization of 37:63 CH:MM Random Copolymers:

the polymerization was performed according to the above procedure. After 10 minutes of the polymerization, the appropriate type of the β-lactam nucleophile (A or B, 0.8-1.0 eq. relative to [I]₀) was added to the reaction vial. The mixture was stirred in the glove box for 18 hours before methanol was added to quench the reaction. The above workup procedure was followed to give the C-terminal functionalized copolymers in protected form.

### General Procedure of Deprotection of 37:63 CH:MM Random Copolymers:

deprotection was accomplished by dissolving the polymer (70-150 mg) in 2 mL neat TFA containing ca. 100 μL triethylsilane. The reaction underwent for 2 hours on a shaker. The resulting deprotected polymer was precipitated by pouring the reaction solution into diethyl ether. The precipitate was collected by centrifugation. The precipitate was then washed by diethyl ether twice. The resulting polymer, after being dried under N₂ stream, was dissolved in 5-10 mL DI water. The solution was freeze-dried to yield the final polymer as a white foam solid. The overall yield is generally higher than 90%.

Table 3 summarizes the characteristics of antimicrobial polymers used for immobilization, according to preferred embodiments of the present invention. The synthesis yielded four antimicrobial polylactams. Two polymers that bear thiol group on their C-terminus and two on their N-terminus (see final structure in Scheme 6).

TABLE 3

| Polymer^{a} | | | | |
|---|---|---|---|---|
| | Batch | | | Chains contain |
| Name | number | Mn (gr/mol)^{b} | Mw/Mn^{b} | thiol group (%)^{c} |
| Z-1 | 87 | 4900 | 1.12 | 30 |
| | 17 | 5269 | 1.08 | 96 |
| Z-2 | 89 | 5400 | 1.11 | 30 |
| | 19 | 6984 | 1.08 | 99 |
| Z-3 | 97 | 5000 | 1.11 | 100 |
| | 23 | 6172 | 1.13 | 100 |
| Z-4 | 93 | 4600 | 1.14 | 100 |
| | 21 | 4363 | 1.14 | 100 |

^{a}See chemical structures in Scheme 6
^{b}Polymers before TFA treatment
^{c}Based on Ellman's test

### Quantitative Biofilm Growth Inhibition Assay by Antimicrobial Polymers Dissolved in Solution in a 96-Wells Microtiter Plate:

Four antimicrobial polymers (Z-1, Z-2, Z-3 and Z-4, Scheme 6) that were synthesized in the laboratory of Prof. Samuel Gellman were evaluated for their ability to inhibit biofilm growth in aqueous solution. The experiment was conducted by a dose-response measurement in a 96-wells polystyrene microtiter plates using Enterobacter as model bacterial strain. Enterobacter culture (50 ml) was grown in tryptic soy broth media (TBS; prepared according to manufacturer instructions) overnight at 25° C. On the next day the turbidity of the culture was measured at 600 nm and, if necessary, TSB was added to dilute the culture until the OD was 1. Then 96 wells polystyrene microtiter plates (flat bottom, transparent, Becton Dickinson, Franklin Lakes, New-Jersey) were filled as following: Negative control wells (without bacteria) were filled with 125 μl TSB media 15 and 25 μl of DDW:PBS 1:1 buffer solution; Positive control wells (without polymer solution) were filled with 110 μl TSB media, 25 μl of DDW:PBS 1:1 buffer solution and 15 μl of Enterobacter culture solution; Wells that contained antimicrobial polymer at different concentrations were filled with 110 μl 20 TSB media, 25 μl of polymer solution and 15 μl of Enterobacter culture solution. The plates were incubated at 25° C. for 18-20 h. On the next day the plates were gently rinsed 5 times with distilled water to remove the planktonic bacteria and then 25 dried at room temperature for 10 minutes. Then the biofilm on the walls of the wells was dyed by adding 200 μl of 0.3% crystal violet (CV) to the wells. After 15 minutes at room temperature, the plates were gently rinsed 5 times with distilled water to remove excess dye and dried at room temperature for 10 minutes. The dry plates were filled with 200 μl ethanol, covered and gently agitated for 1 hour. The absorbance of extracted color was measured in a plate reading spectrophotometer (Infinite M200, Tecan, Mannedorf, Switzerland) at 595 nm.

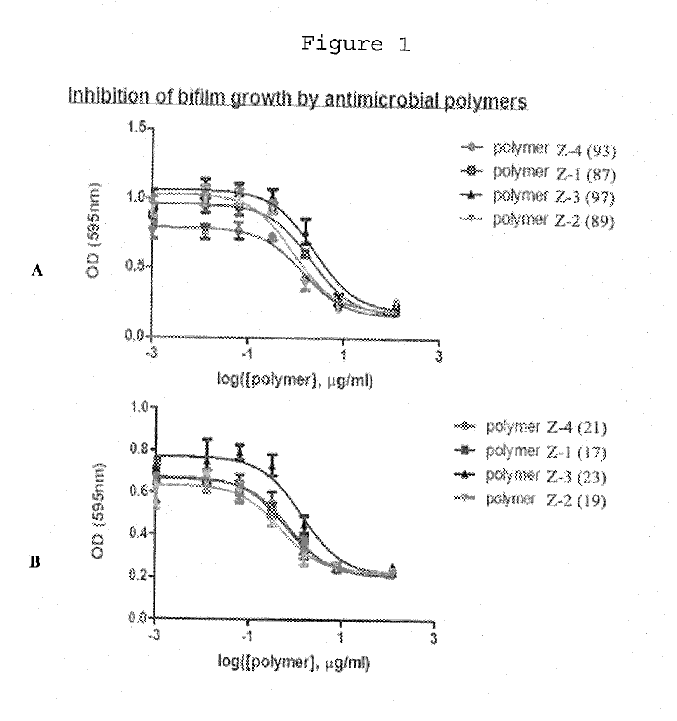

FIG. 1 depicts the inhibition of biofilm growth of Enterobacter by antimicrobial nylon-3 copolymers in solution, measured in 96-microtiter plate: (A) dose-response curves of four antimicrobial polymers (batch 87, 89, 97, 93) and (B) dose-response curves of four antimicrobial polymers (batch 17, 19, 23, 21). The results suggest that biofilm growth of Enterobacter is strongly inhibited by dissolved antimicrobial polymers Z-1, Z-2, Z-3 and Z-4. All four polymers showed comparable inhibition potencies, with the strongest inhibition of Polymer Z-2.

IC₅₀ values for the inhibition of biofilm growth of Enterobacter by dissolved antimicrobial polymers which was calculated from doze-response curves are presented in Table 4.

TABLE 4

Polymer

| Name | Batch | IC₅₀ [μg/ml]^{a} |
|---|---|---|
| Z-1 | 87 | 2.06 ± 0.09 |
| | 17 | 0.57 |
| Z-2 | 89 | 0.60 ± 0.30 |
| | 19 | 0.47 |
| Z-3 | 97 | 2.60 ± 0.40 |
| | 23 | 1.36 |
| Z-4 | 93 | 1.30 ± 0.08 |
| | 21 | 0.73 |

^{a}Values for polymer batch 87, 89, 97, 93 are average of two independent experiments; The standard deviation is given for batch numbers 87, 89, 97, 93;

### EXAMPLES

### Example 1A

### Immobilization of Antimicrobial Polylactam Copolymers on RO Membrane Via Linear Immobilization

Step 1 (Scheme 5): Attachment of Diamine Tether to the Membranes

RO membranes (1×2 cm²) were glued to glass slides, soaked in 70% ethanol for 5-10 minutes and then washed in DDW 3 times for 10 minutes in a sonication bath. Each reaction vessel containing a membrane sample was filled with a sodium phosphate buffer solution (0.1 M, pH 7.4) containing 20 mM N-hydroxysulfosuccinimide sodium salt (sulfo-NHS), 20 mM N-(3-dimethylaminopropyl)-N′-ethylcarbodiimide hydrochloride (EDC) and 60 mM diamine tether (Jeffamine300 or Jeffamine500) to coat the membranes (about 1 mL solution), and the solution was agitated on a Unimax 1010 orbital platform shaker (Heidolph, Kelheim, Germany) at room temperature overnight.

Step 2 (Scheme 5): Attachment of Maleimide (MI) Group to Diamine Tether on RO Membrane

The solution used to modify five membranes (modified with diamine tether, 1×2 cm² each) was prepared as follows: 31.7 mg 6-maleimidohexanoic acid (MI-hexanoic acid; 0.15 mmol) were dissolved in 1.0-2.0 mL DDW. The pH of the solution was raised to 7.4 using 0.1 N NaOH at 0° C. while stirring, and a sodium phosphate buffer solution (0.1 M, pH 7.4) was added to reach a final volume of 7.5 mL. Then, 1.5 mL of the resulting solution was added to each membrane, followed by 150 μL of 0.2 M sulfo-NHS in sodium phosphate buffer (0.1 M, pH 7.4) and 150 μL of 0.2 M EDC in the same buffer. The reaction was agitated at room temperature on an orbital shaker overnight. The membranes were washed and kept as described in former step.

Step 3 (Scheme 5): Attachment of the Antimicrobial Polymer Containing a Thiol Side Group to the Tethered Membrane

The thiol-modified antimicrobial polymer (2-3 mM) was dissolved in ˜0.5 mL DI water to reach concentration of 1-2 mM and the solution was adjusted to pH=7.4 by NaOH 0.1 N at 0° C. while stirring vigorously. The solution was diluted to a final volume of 1.5 ml with sodium phosphate buffer (100 mM, pH 7.4) together with ACN (up to 300 μl) if precipitation occurred. The final polymer solution was supplemented to the membrane. The reaction was agitated on a shaker at room temperature overnight. The membranes were washed and kept as described in previous step.

Flow Cell Testing of the Modified Membranes Against Biofouling:

The modified membranes described in Example 1 were tested in a flow cell system using Pseudomonas aeruginosa bacteria that express GFP (Green Fluorescent Protein). The bacteria were pumped to the membrane cell in a flow rate of 50 ml/hour for 1 hour. After that time, growing medium flows through the cell in the same flow rate for 20 h in 37° C. to wash the unbound bacteria and to supply the attached bacteria suitable conditions to develop biofilm. Then, the fluorescence of the biofilm was detected by confocal laser scanning microscope (CLSM) giving a quantitative analysis, which gives an indication of the biofilm thickness and volume.

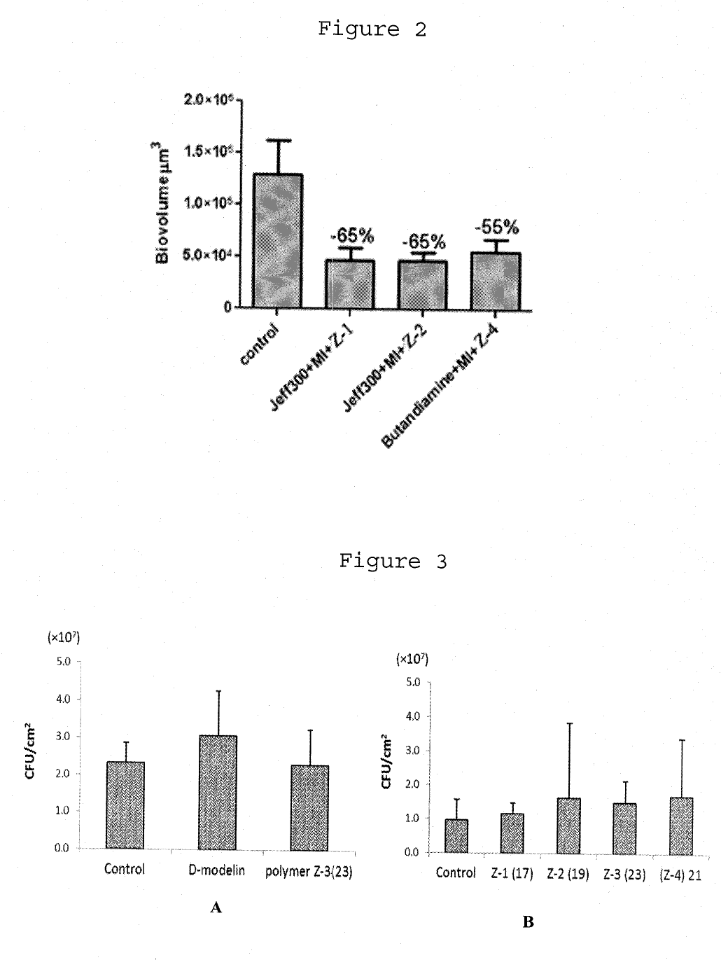

FIG. 2 depicts biofilm volume on RO membranes immobilized with three polymers, Jeffamine300-MI-Z-1, Jeffamine300-MI-Z-2 and Jeffamine300-MI-Z-4 in comparison to control membrane.

The analysis of the CLSM images (FIG. 2 and Table 5) suggests that the volume of the biofilm formed on membranes modified with polymer Z-1 (batch 87) and polymer Z-2 (batch 89) were 35% and 25% lower than the control membrane, respectively. Polymer Z-4 (batch 93) showed similar biofilm volume as the control and the biofilm formed on a membrane modified with polymer Z-3 (97) was 60% larger than the control membrane.

TABLE 5

| Biovolume | | Z-1 | | Z-2 | Z-4 |
|---|---|---|---|---|---|
| μm³ | control | (87) | Z-3 (97) | (89) | (93) |
| Average | 71660 | 45423 | 114242.8 | 53383.5 | 67140 |
| STDEV | 6366 | 7199 | 11919 | 8546 | 7681 |

The polymers show clear effect on the resulted volume of the biofilm detected on the membrane. There were significant differences in inhibition of biofilm growth between the polymers: Polymers Z-1 and Z-2 showed the highest biofilm inhibition; these polymers (Z-1 and Z-2) were bound to the RO membrane via their C-terminus (thiol group is located at the C-terminus of polymers). On the other hand, polymers Z-3 and Z-4 were bound to the membrane via their N-terminus and showed no inhibition.

### Example 1B

### Linear Immobilization of Antimicrobial Polymers on RO Membranes and Inhibition of Biofilm Growth, at Different Polymer Concentrations

LE-400 RO membranes were immobilized with antimicrobial polymers according to Scheme 5 and Example 1 except for the following changes: 1) the whole immobilization procedure was performed with membranes that were immersed in the reaction solution, and were glued to the glass slides only after the polymer immobilization was completed. 2) the final concentration of EDC, sulfo-NHS and Jeffamine300 at the first step of modification (step (1) in Scheme 5) was 20 mM:20 mM:60 mM, respectively 3) The final concentration of EDC, sulfo-NHS and MI at the second step of modification (step (2) in Scheme 5) was 20 mM:20 mM:20 mM, respectively. In this example the two soluble polymers were used: polymer Z-2 (19) and polymer Z-4 (21). Each polymer was immobilized in three different concentrations, hence 1 mM, 2 mM, and 3 mM. CLSM analysis of biofilm growth on RO membranes immobilized with the polymers is shown in Table 6.

TABLE 6

| Biovolume | | Z-2 (19), | Z-2 (19), | Z-2 (19), | Z-4 (21), | Z-4 (21), | Z-4 (21), |
|---|---|---|---|---|---|---|---|
| μm³ | Control | 1 mM | 2 mM | 3 mM | 1 mM | 2 mM | 3 mM |
| Average | 31233.5 | 101562.3 | 90956.25 | 106783.8 | 2182.5 | 70374.75 | 100031 |
| STDEV | 21746.47 | 51585 | 17305.59 | 10475.98 | 1184.757 | 21004.3 | 26086.27 |

### Example 1C

### Linear Immobilization of Antimicrobial Polymers on RO Membranes and Inhibition of Biofilm Growth, Where the Attachment is Via the Amine or the Carboxy Side

LE-400 RO membranes were modified according to Scheme 5 and Example 1B by four antimicrobial polymers and the results are presented in Table 7.

TABLE 7

| Biovolume | | | | | |
|---|---|---|---|---|---|
| μm³ | control | Z-1 (17) | Z-3 (23) | Z-4 (21) | Z-2 (19) |
| Average | 115277.5 | 110999 | 37571.83333 | 82425.83333 | 104023.5 |
| STDEV | 5483.154813 | 30054.40759 | 26184.39594 | 15300.89806 | 29889.87623 |

The analysis of the CLSM images shows that membranes modified with polymer Z-3 (23) and polymer Z-4 (21) reduced biofilm formation by 68% and 29%, respectively, compared to the control membrane. Polymer Z-1 (17) and polymer Z-2 (19) had no effect on biofilm growth. The results suggest that polymers immobilized to the RO membrane through their amine terminal (polymers Z-3 and Z-4) showed inhibition of biofilm growth, whereas polymers immobilized via their carboxyl terminal (polymers Z-1 and Z-2) had no effect on biofilm growth. Hence, immobilization through amine terminal retains the antimicrobial activity of the polymer.

### Example 1D

### Physicochemical Measurements of the Immobilized Membranes Immobilized by Linear Immobilization

### I) Sessile Water Drop Contact Angle Measurements:

Membranes in the size of approximately 2*2 cm were modified as described in Scheme 5 and in Example 1 except for the following changes: 1) The membranes were not glued to glass slides; 2) the final concentration of EDC, sulfo-NHS and butandiamine (step (1) in Scheme 13) was 10 mM:10 mM:30 mM, respectively (1^{st} and 2^{nd} experiment) and 20 mM:20 mM:60 mM, respectively (3^{rd} experiment), 3) The final concentration of EDC, sulfo-NHS and MI (step (2) in Scheme 13) was 10 mM:10 mM:10 mM, respectively (1^{st} and 2^{nd} experiment) and 20 mM:20 mM:20 mM, respectively (3^{rd} experiment).

After modification the membranes were dried in the desiccator and contact angles were measured with a sessile drop of water or with captive bubble technique using contact angle analyzer. An average of at least 5 drops (0.5 μL) was used to characterize each membrane sample. The results are presented in Table 8 below.

As can be seen in Table 8, the attachment of Jeffamine and MI-hexanoic acid made the membrane slightly more hydrophilic. The attachment of the antimicrobial polymers, however, made the membrane more hydrophobic, probably due to its hydrophobic face. Those results are in agreement with previous studies of some of the present inventors, that showed that attachment of antimicrobial polymers resulted in membranes that were more hydrophobic than membranes with Jeffamine only (data not shown).

TABLE 8
Sessile water drop contact angel measurements of LE-400 membrane
modified with Jeffamine 300 MI-hexanoic acid and antimicrobial polymer.

| RO membrane | | | | | |
|---|---|---|---|---|---|
| Modification | 1st experiment | | 2nd experiment | | 3rd experiment^{b} |
| Unmodified | (51.0 ± 1.5)°^{a} | | (55.8 ± 2.5)°^{a} | | (63.6 ± 2.4)° |
| membrane | | | | | |
| Jeffamine | (46.2 ± 1.7)° | | (55.4 ± 1.8)°^{a} | | (61.9 ± 2.1)° |
| (b, Scheme 5) | | | | | |
| MI | (43.4 ± 1.6)°^{a} | | (45.9 ± 3.0)°^{a} | | (52.0 ± 2.7)° |
| (c, Scheme 5) | | | | | |
| Z-1 (17) | — | | (85.6 ± 2.8)°^{b} | | (86.2 ± 3.0)° |
| Z-2 (19) | — | | (74.1 ± 3.2)°^{b} | | (70.2 ± 4.0)° |
| Z-3 | (batch | (70.4 ± 1.7)°^{b} | (batch | (92.2 ± 3.1)°^{b} | (72.2 ± 5.7)° |
| | 97) | | 23) | | |
| Z-4 | (batch | (61.7 ± 1.5)°^{b} | (batch | (66.3 ± 2.6)°^{b} | (72.1 ± 3.7)° |
| | 93) | | 21) | | |

^{a}Values are average of two membrane samples; for each sample an average of at least five drops was performed.
^{b}Values are an average of one membrane sample; for each sample an average of at least five drops was preformed

### II) Captive Bubble Technique Measurements:

In the captive bubble technique, a drop (1 μL) of heptane or an air bubble in a small vessel of water was delivered to the Membrane-water interface. For this experiment the membranes were kept in water after modification and were not dried. This allowed to study the influence on the modification on the surface in solution, instead of in a dry state. The results are presented in Table 9.

TABLE 9
captive bubble technique for hydrophobicity measurements
of LE-400 membrane modified with Jeffamine 300 MI-hexanoic acid
and antimicrobial polymer.

| | Heptane | Heptane | |
|---|---|---|---|
| Modification | 1st experiment | 2nd experiment^{a} | Air^{a} |
| Un-modified | (22.4 ± 4.0)°^{a} | (17.8 ± 2.3)° | (19.9 ± 2.0)° |
| Jeffamine | (18.4 ± 1.8)°^{a} | (18.3 ± 2.0)° | (20.0 ± 1.6)° |
| MI | (20.0 ± 3.4)°^{a} | (15.9 ± 1.6)° | (19.2 ± 1.4)° |
| Z-1 (17) | (36.4 ± 2.6)°^{b} | (25.6 ± 2.0)°^{b} | (24.3 ± 1.9)° |
| Z-2 (19) | (27.5 ± 3.3)°^{b} | (28.1 ± 2.0)° | (24.8 ± 1.6)° |
| | | (20.1 ± 2.9)° | |
| Z-3 (23) | (43.7 ± 4.0)°^{b} | (19.8 ± 2.2)° | (25.4 ± 1.8)° |
| Z-4 (21) | (32.4 ± 0.8)°^{b} | (15.9 ± 1.6)° | (22.2 ± 1.9)° |
| | | (23.7 ± 1.5)° | |

^{a}Values are average of two membrane samples; for each sample an average of measurements of at least five drops were performed.
^{b}One membrane sample was measured, for each sample an average of measurements of at least five drops.

The results presented in Table 9 and suggest that the antimicrobial polymers increase the hydrophobicity of the membrane surface. In this case the polymers hydrophilic face would adhere to the membrane while the hydrophobic face would be exposed to the air.

III) Evaluation of Biofilm Growth on RO Membranes Immobilized with Antimicrobial Polylactams

The biofilm growth on the modified membranes was studied in two different systems: static conditions in our laboratory and a flow cell system at the laboratory of Dr. Ehud Banin.

Static Condition System

RO Membranes (1.6×0.8 cm²) were glued to glass slide, modified according to the linear procedure (Scheme 5) and incubated in 25° C. with Klebsiella oxytoca. The membranes were then washed and sonicated in PBS. The buffer was diluted, inoculated and CFUs were counted. The results are presented in FIG. 3.

FIG. 3 depicts biofilm quantification in static conditions on RO membranes; (A) Comparison between unmodified membrane and membranes modified with the AMP D-modelin-1 and antimicrobial polylactam Z-3; (B) Comparison between unmodified membrane and membranes modified with antimicrobial polylactams (Z-1, Z-2, Z-3, and Z-4). All polymers were attached to the membrane according to the linear procedure (Scheme 5) through Jeffamine500.

FIG. 3A shows a comparison between membranes immobilized with the AMP D-modelin-1 by the linear procedure and a membrane immobilized with antimicrobial polymer Z-3 (batch 23) according to Scheme 5. It was found that membranes modified by the linear procedure, either with antimicrobial polymer or antimicrobial polymer did not show significant differences in biofilm growth compared to the control membrane (Nested ANOVA: F_{3,9}=1.13, p=0.389). FIG. 3B shows the results of biofilm growth on four membranes that were immobilized with four different antimicrobial polymers by the linear procedure. It was found that there were no significant differences between the biofim growth on the control compared with the modified membranes (Nested ANOVA: F_{4,14}=0.16, p=0.953). The results suggest that antimicrobial polylactams that were immobilized by the linear procedure are not active against bacteria, however, large deviations of measurements require repeating of this experiment in order to achieve reliable conclusion regarding the efficiency of the method.

### Flow Cell System

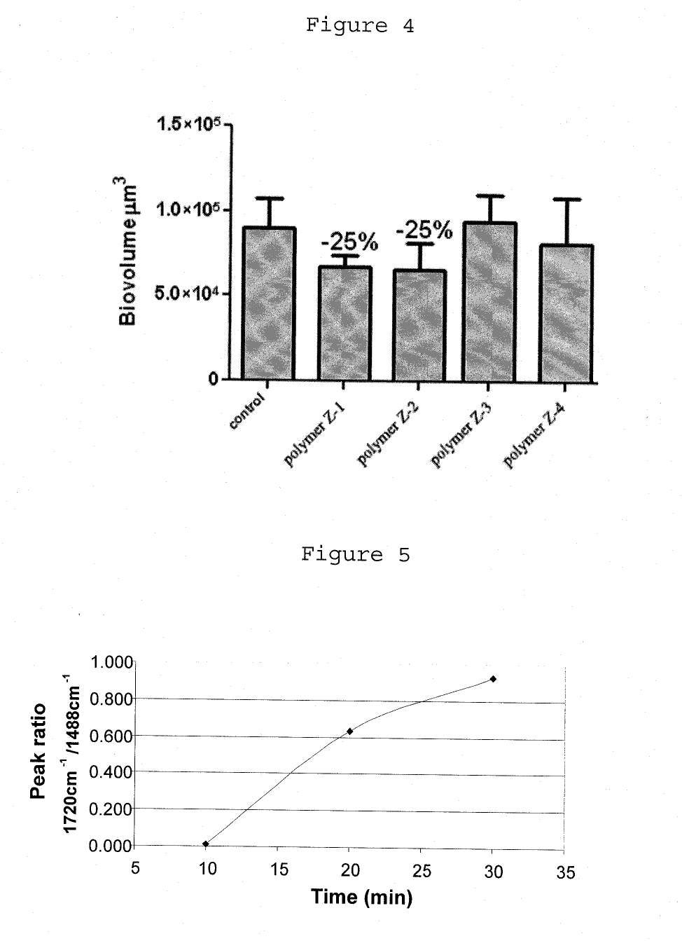

RO membranes (1×2 cm²) were glued to glass slides and immobilized with antimicrobial polymers. The slides were placed in a flow cell where biofilm growth of GFP expressing Pseudomonas aeruginosa was measured and quantified by CLSM. The images from the CLSM were analyzed for quantification of biofilm structure and the results are presented in FIG. 4.

The analysis of the CLSM images suggests that membranes modified with polymer Z-1 and polymer Z-2 reduced biofilm formation by 25%, respectively, compared to the control membrane. Polymer Z-3 and polymer Z-4 had no effect on biofilm growth compare to the unmodified membrane. Since the results from the flow cell system were not statistically analyzed, the decrease in biofilm formation is inconclusive. FIG. 4 depicts a quantitative analysis of biofilm volume that was grown on RO membranes in a flow cell: unmodified membrane (control), membranes modified with four antimicrobial polymers (Z-1, Z-2, Z-3 and Z-4). All polymers attached to the membrane according to Scheme 5 using Jeffamine500 as a tether.

### Example 2A

### Immobilization of Antimicrobial Polylactam Copolymers on RO Membrane Via Multivalent Immobilization

Four different polylactams (Scheme 6) were immobilized on aromatic polyamide RO membranes through multivalent immobilization according the following procedure:

Step I: Redox-Initiated Graft Polymerization of RO Membranes.

LE-400 RO membranes (1×2 cm²) were glued to glass slides, were rinsed with 70% (v/v) ethanol, were placed in a reaction vessel and washed 3×10 minutes with DI water in a sonication bath. Redox-initiated graft polymerization was performed in aqueous solution (25 mL) containing the monomers 0.85 mL methacrylic acid (MA; 10 mmol) and 0.81 mL poly(ethylene glycol) methacrylate (PEGM; 2.5 mmol) at 25° C. (0.1 M and 0.3 M, respectively). The initiators K₂S₂O₈ and K₂S₂O₅ were dissolved in DI water to reach a final equimolar concentration of 0.01M and were added to the monomer solution while stirring. Subsequently RO membrane pieces (1×2 cm²) were immediately immersed in the grafting solution and the reaction was carried out for 20 minutes at 25° C. The membranes were washed with DDW in the sonicator for 15 minutes 3 times in order to remove unreacted monomer and homopolymer and then three times for 15 minutes each in DI water in a sonication bath. The membranes were stored in DI water at 4° C. The procedure continued as described for the membrane modification by the linear method (Example 1) except for the following changes: 1) the final concentration of EDC, sulfo-NHS and amine-tether (step (2) in Scheme 5) was 10 mM:10 mM:30 mM, respectively 2) The final concentration of EDC, sulfo-NHS and MI (step (3) in Scheme 5) was 10 mM:10 mM:10 mM, respectively.

The modified membranes were tested in flow cell system with Pseudomonas aeruginosa bacteria that expresses GFP (Green Fluorescent Protein). The fluorescence of the biofilm was detected by confocal laser microscope, and quantitative analysis gave an indication of the thickness and volume of the biofilm formed.

The analysis of the CLSM images and Table 7 (local) of RO membranes immobilized via multivalent immobilization according to Scheme 13 shows that the volume of the biofilm formed on RO membranes modified with polymer Z-1 (87) and polymer Z-2 (89) was 65% lower than biofilm on unmodified (control) membrane. The tether used in binding both polymers Z-1 and Z-2 was Jeffamine. Polymer Z-4 (93) which was attached with multivalent immobilization and butane-diamine as a tether, reduced the biofilm formation by 55%. A fourth sample which contained polymer Z-3 (97) was damaged during the experiment, therefore it is not shown.

The volume of iodofilm which was formed on the control membrane (129,220 μm³) was higher than usual values obtained for control membranes under these conditions.

TABLE 10

| | | | | | Butane- |
|---|---|---|---|---|---|
| | | Jeff300 + | Jeff300 + | PEG3000 + | diamine + |
| Biovolume | | MI + Z-1 | MI + Z-2 | MI + Z-3 | MI + Z-4 |
| μm³ | Control | (87) | (89) | (97) | (93) |
| Average | 129224 | 46677 | 47050 | No results | 56391 |
| STDEV | 32887 | 12673 | 7970 | No results | 11522 |

### Example 2B

### Immobilization of Antimicrobial Polylactam Copolymers on RO Membrane Via Multivalent Immobilization Using Butanediamine as Tether

RO membranes were modified according to the procedure presented in Scheme 13 and Example 2A except the following changes: 1) methacrylic acid and polyethylene glycol metahcrylate (PEGM) were in concentration of 0.8 M and 0.2 M, respectively. Four samples of RO membrane was prepared, each with a different polymer.

### Example 2C

### Characterization of Membranes Immobilized by Multivalent Immobilization

### I. Sessile Drop Method for Contact Angle Measurements

Contact angle measurements were performed to membranes that were modified by the multivalent approach as described in Scheme 13 and Example 2 except the following change:

1) Membrane size was approximately 2*2 cm.
2) Methacrylic acid and polyethylene glycol metahcrylate was in concentration of 0.4 M and 0.1 M, respectively.
3) The polymer-amine that was used (step (2) in Scheme 13) was Jeffamine500
4) The final concentration of EDC, sulfo-NHS and Jeffamine (step (2) in Scheme 13) was 20 mM:20 mM:60 mM, respectively
5) The final concentration of EDC, sulfo-NHS and MI (step (3) in Scheme 13) was 20 mM:20 mM:20 mM, respectively.

Prior to the measurement, the membranes were dried in the desiccator. Contact angles of water were measured using the sessile drop method using contact angle analyzer. A 0.5 μl water drop was delivered to the membrane surface. Three membrane samples were prepared for every step of the modification and for each membrane sample an average of at least five drops was measured. The results are presented in Table 11.

TABLE 11
Sessile water drop contact angle measurements of LE-400
membrane modified with graft polymerization, Jeffamine 500 MI-hexanoic
acid and antimicrobial polymer.

| | | | | After | After | After | After |
|---|---|---|---|---|---|---|---|
| | | | | Jeffamine500 + | Jeffamine500 + | Jeffamine500 + | Jeffamine500 + |
| Unmodified | After Graft | | After | MI + | MI + | MI + | MI + |
| FILMTECH | polymerization | After | Jeffamine500 + | Polymer Z- | Polymer Z-1 | Polymer | Polymer Z-3 |
| LE-400 | MA:PEGM | Jeffamine500 | MI | 2 (19) | (17) | Z-4 (21) | (23) |
| membrane | 0.4:0.1 | modification | modification | Modification | Modification | Modification | Modification |
| (53.7 ± 2.1)° | (41.9 ± 2.6)° | (47.6 ± 1.8)° | (46.2 ± 2.6)° | (56.5 ± 4.5)° | (77.3 ± 4.1)° | (63.6 ± 3.6)° | (75.9 ± 2.7)° |

^{a}Values are average of three membrane samples; for each sample measurements of at least five drops were performed.

Graft polymerization made the membrane more hydrophilic (Table 11). This can be due to low modification according to IR peak values and so the polymer maybe did not collapsed on the membrane.

### II. ATR-FTIR Measurements

To detect RO membrane modification by FTIR, LE-400 RO membranes were immobilized according the procedure described in Scheme 13 and with the modifications of the previous section. The modified membranes were characterized by ATR-FTIR spectrometer with a one-reflection diamond-coated KRS-5 element (Pike). The ATR-FTIR spectra confirmed that graft polymerization was achieved successfully as evident by two new IR peaks: at 950 cm⁻¹, which is related to the ether group in PEGMA, and at 1720 cm⁻¹, attributed to the ester-carbonyl group of the polymethacrylate. The immobilization of antimicrobial polylactam (step 4 in Scheme 13) was harder to detect since the RO membrane contains amide bonds that absorb in the same IR range (1660 cm⁻¹), and mask the polylactam amide adsorption. A reference IR spectrum of bulk polymer 21 was measured.

In order to examine whether the procedure was successful, the immobilization was carried out on PAN-HV3 Ultra-Filtration membrane which was made of poly-acrylonitrile (PAN). PAN does not contain amide bond. ATR-FTIR spectra confirmed the modification steps on PAN-HV3 membrane according to Scheme 13; an amide CO double bond stretch can be seen at 1660 cm⁻¹, which can be attributed to the antimicrobial polylactam. Hence, the antimicrobial polymer was observed by IR on PAN membrane and suggests that the immobilization was successful.

### Static Results

Biofilm Growth—Static Conditions Results:

It was found that there was a significant difference in the biofilm content by means of CFU/cm² among the different treatment levels (Nested ANOVA: F4,14=5.90, p=0.005). Specifically, it was found that biofilm formed on the unmodified membrane was significantly higher (1.3×10⁷±1.3×10⁶ CFU/cm²) than biofilm formed on the membranes immobilized with antimicrobial polylactams (Z-2, Z-3 and Z-4) by the multivalent procedure.

Most polymers resulted in reduction in biofilm formation on RO membranes upon immobilization through the multivalent procedure. It should be noted that membrane immobilized with polymer Z-1 resulted in unexpected high standard deviation and thus the measurement on membrane modified with polymer Z-1 must be repeated in order to achieve reliable conclusion regarding the inhibition potency of this polymer.

### Biofilm Growth—Flow Cell System Results

For measuring biofilm growth in flow conditions membranes were modified with graft polymerization by using MA:PEGM 0.4M:0.1M according to Scheme 13, with two polymers (Z-2 and Z-4) that were immobilized through two different tether amines—PEGamine3000 or butandiamine. The membranes were studied in a flow cell system with GFP expressing P. aeruginosa and biofilm fluorescence was detected by CLSM. The images were analyzed for quantification of biofilm structure and the results were analyzed, suggesting that membranes immobilized with polymer Z-2 through PEGamine and butandiamine as amine tethers reduced biofilm formation by 43% and 50%, respectively. Membranes immobilized with polymer Z-4 through butandiamine reduced biofilm formation by 25%.

### Example 2D

### Optimization of Graft Polymerization

Redox initiated graft polymerization method (Step 1 in Scheme 13) is a promising method to yield a high carboxyl density. In this work methacrylic monomers were used for attachment to the surface of RO membrane.

In order to optimize the graft polymerization reaction, a screen was performed to evaluate the most suitable conditions of temperature as well as polymerization time. The analysis showed that graft polymerization changed the membrane surface, mainly by two new peaks in FTIR; a peak at 1722 cm⁻¹ that is assigned to the appearance of carbonyl of carboxyl and ester groups and a peak at 945 cm⁻¹ which is possibly the etheric bond of the ethylene glycol in PEGMA monomer. The peaks at 1242 cm⁻¹ and 1488 cm⁻¹ are characteristics for aromatic rings of the polyamide membrane and estimation of grafting density was calibrated according to one of them.

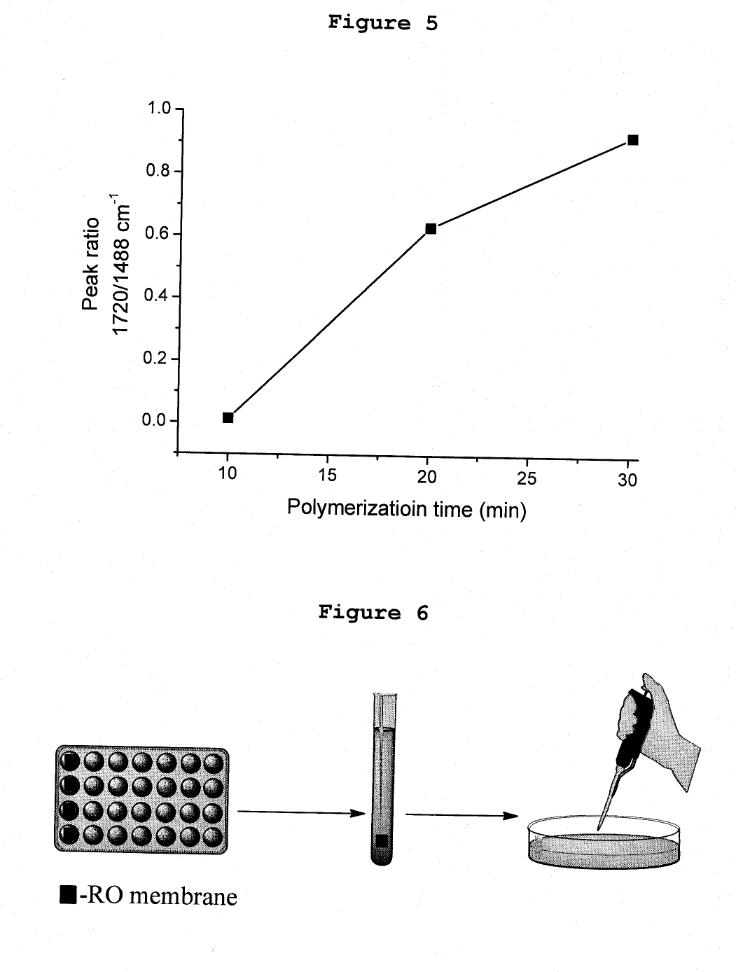

Membranes modified with graft co-polymerization of the monomers MA:PEGM at concentrations of 0.4:0.1 at 25° C. for three different polymerization times. The reaction was preformed using K₂S₂O₅, K₂S₂O₈ in a concentration of 0.1M. Duplicate membrane samples were prepared for every reaction condition and for every sample at least 4 different measurements were performed. A calculated IR peak ratio between the grafted polymer (1729 cm-1) and the polyamide RO membrane (1488 cm-1) shows (in FIG. 5) that the graft polymerization increases as the reaction time extends.

ATR-FTIR spectrum was obtained for membranes modified with graft polymerization of the monomers MA:PEGM at concentrations of 0.4:0.1 for 20 minutes or 30 minutes. An analysis of ratio of IR peak intensities showed that the graft yield increases with increase in temperature.

It was concluded that the optimal conditions for grafting for the immobilization of antimicrobial polylactams were 20 minutes at 25° C. to achieve a mild grafting density in order to avoid too intense grafting coverage of the membrane surface.

1. An antimicrobial water treatment membrane comprising a water treatment membrane, covalently attached to one or more antimicrobial polymers or derivatives thereof, via one or more tether molecules.

2. The antimicrobial water treatment membrane of claim 1, wherein:
i) said antimicrobial polymer has an IC₅₀ value of up to 200 μg/ml against at least one biofilm-forming microorganism; and
ii) each of said tether molecules is independently attached to said antimicrobial polymer and/or to said membrane via a bond selected from an amide bond, a thioether bond, a carbon-carbon bond, a carbon-nitrogen bond, an azide-alkyne bond, a hydrazine-aldehyde bond and an Avidin-biotin (host-guest) complexation.

3. The antimicrobial water treatment membrane of claim 1, wherein said water treatment membrane is selected from a reverse osmosis (RO) membrane, a nanofiltration (NF) membrane, an ultrafiltration membrane (UF), or a thin film composite (TFC) membrane.

4. The antimicrobial water treatment membrane of claim 1, wherein said membrane is attached to a single antimicrobial polymer chain, thereby forming a linear immobilized membrane.

5. The antimicrobial water treatment membrane of claim 1, wherein said membrane is attached to more than one antimicrobial polymer chain, thereby forming a multivalent immobilized membrane.

6. The antimicrobial water treatment membrane of claim 1, wherein said tether:
a) is an oligomer or a polymer having a molecular weight (MW) of at least 300 grams/mol,
b) has an extended length (EL), in an aqueous environment, of at least 1.5 nanometers; and
c) has a ratio between said MW and said EL which is lower than 1,200 g/mol per 1 nanometer.

7. The antimicrobial water treatment membrane of claim 6, wherein said tether molecule is selected from: a Poly Ethylene Glycol (PEG) polymer, water soluble polyethers that are derivatives of polyethylene-glycol, a poly-acrylamide polymer, a poly-(D)-lysine polymer, a polyacrylate, a diamine polymer and poly-(D)-Aspartic acid.

8. The antimicrobial water treatment membrane of claim 5, wherein said tether is selected from butanediamine, ethanediamine and hexanediamine.

9. The antimicrobial water treatment membrane of claim 1, wherein said antimicrobial polymer is selected from polylactams, poly-amino acids and polymers containing tertiary and/or quaternary ammonium groups.

10. The antimicrobial water treatment membrane of claim 9, wherein said antimicrobial polymer is a polylactam.

11. The antimicrobial water treatment membrane of claim 1, having a structure selected from structures I-III: 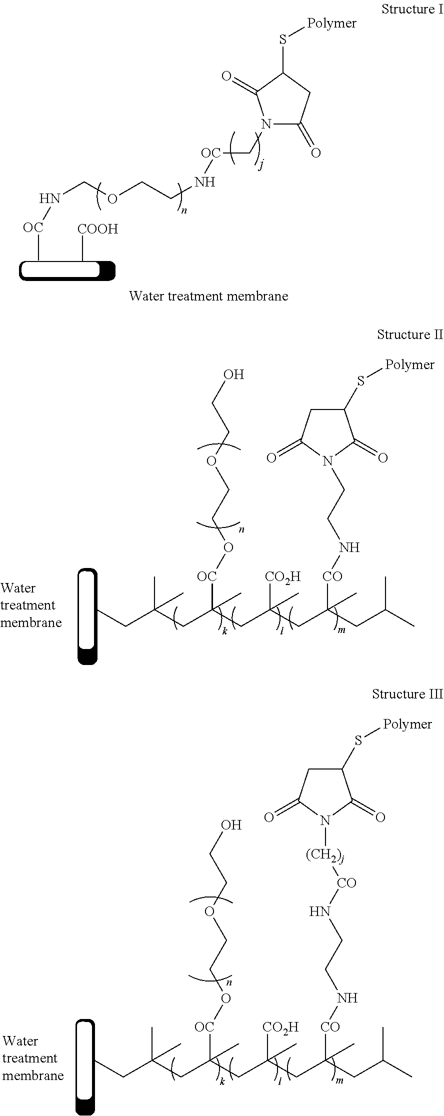
Wherein j, k, l, m and n are integers independently larger than 1, and the polymer is selected from polylactams, poly-amino acids and polymers containing tertiary and/or quaternary ammonium groups.

12. The antibacterial membrane of claim 1, for use in water purification, sea-water desalination, waste water treatment, brackish water treatment, industrial water treatment and water recycling.

13. A process for preparing an antimicrobial water treatment membrane, said process comprising immobilizing one or more antimicrobial polymers or derivatives thereof on a water treatment membrane, by covalently attaching said polymer and said membrane via one or more tether molecules, wherein:
i) said tether molecule has at least two terminating groups, each being independently selected from a maleimide (MI) group, 6-aminohexanoic acid, a thiol group, an azide group, an amine group, a carboxyl group or an acetylene group;
ii) said membrane and said polymer independently have at least one terminating group being selected from a maleimide (MI) group, 6-aminohexanoic acid, a thiol group, an azide group, an amine group, a carboxyl group or an acetylene group; and
iii) said antimicrobial polymer has an IC₅₀ value of up to 200 μg/ml against at least one biofilm-forming microorganism.

14. The process of claim 13, wherein the preparation of said antimicrobial polymer and/or the modification of said polymer is conducted “off membrane”.

15. The process of claim 13, wherein said process is conducted at a temperature ranging from about 15° C. to about 40° C.

16. The process of claim 13, said process comprising:
a) attaching at least one diamine tether to said membrane to obtain a tethered membrane;
b) attaching a maleimide (MI) linker to said tethered membrane to obtain an MI-linked-tethered membrane; and
c) attaching at least one antimicrobial polymer containing a thiol side group to said MI-linked-tethered membrane to obtain an antimicrobial polymer linearly immobilized on said membrane.

17. The process of claim 13, wherein said tether:
a) is an oligomer or a polymer having a molecular weight (MW) of at least 300 grams/mol,
b) has an extended length (EL), in an aqueous environment, of at least 1.5 nanometers; and
c) has a ratio between said MW and said EL which is lower than 1,200 g/mol per 1 nanometer.

18. The process of claim 13, further comprising graft polymerizing monomers present on said membrane, prior to said immobilizing, wherein said polymerizing is conducted in the presence of at least one initiator, thereby obtaining an antimicrobial polymer multivalently immobilized on said membrane.

19. The process of claim 18, wherein said monomers are selected from acrylate- and methacrylate-derivatives, maleic anhydride, ethylene, ethylene-glycol derivatives vinyl-pyrrolidone, vinyl-derivatives that have carboxyl or amine groups, and styrene derivatives.

20. The process of claim 19, wherein said monomers are methacrylate monomers.

21. Use of an antimicrobial water treatment membrane, covalently attached to one or more antimicrobial polymers or derivatives thereof, via one or more tether molecules, in antimicrobial water purification processes selected from: sea-water desalination, waste water treatment, brackish water treatment, industrial water treatment and water recycling.

22. The use according to claim 21, wherein said antimicrobial water treatment membrane comprises a water treatment membrane being covalently attached to one or more antimicrobial polymers or derivatives thereof via one or more tether molecules, wherein said antimicrobial polymer has an IC₅₀ value of up to 200 μg/ml against at least one biofilm-forming microorganism, and further wherein said tether is attached to said antimicrobial polymer and/or to said membrane via a bond selected from an amide bond, a thioether bond, a carbon-carbon bond, a carbon-nitrogen bond, an azide-alkyne bond, a hydrazine-aldehyde bond and an Avidin-biotin (host-guest) complexation.

23. An antimicrobial water purification process, comprising contacting a water source with an antimicrobial water treatment membrane, wherein:
i) said antimicrobial water treatment membrane comprises a water treatment membrane being covalently attached to one or more antimicrobial polymers or derivatives thereof via one or more tether molecules, wherein said antimicrobial polymer has an IC₅₀ value of up to 200 μg/ml against at least one biofilm-forming microorganism, and further wherein said tether is attached to said antimicrobial polymer and/or to said membrane via a bond selected from an amide bond, a thioether bond, a carbon-carbon bond, a carbon-nitrogen bond, an azide-alkyne bond, a hydrazine-aldehyde bond and an Avidin-biotin (host-guest) complexation; and
ii) said water source being selected from sea-water, waste water, brackish water, industrial water, irrigation water and drinking water.
